(19) United States
(12) Patent Application Publication
(10) Pub. No.: US 2007/0199299 A1
(43) Pub. Date: Aug. 30, 2007

(54) Combustion Engine

(76) Inventor: Gerald E. Kashmerick, Brookfield, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/680,624

(22) Filed: Feb. 28, 2007

Related U.S. Application Data
(63) Continuation-in-part of application No. 11/512,454, filed on Aug. 29, 2006.
(60) Provisional application No. 60/712,068, filed on Aug. 29, 2005.

(51) Int. Cl. F02G 1/00

(52) U.S. Cl. 60/39.6

(57) ABSTRACT

A combustion engine that has at least a plurality of power strokes during a complete cycle of engine operation that is of compact packaging and Brayton cycle or modified Brayton cycle operable. In some embodiments, a piston-cylinder arrangement is used to compress air and deliver it to a combustion chamber where it is combusted along with fuel, while in some embodiments, at least some of the compressed air is delivered to and stored in a pressure vessel. The pressurized air stored in pressure vessel can be delivered to the combustion chamber or can pneumatically power various engine or vehicle accessories. Combustion gases are returned back to the piston-cylinder arrangement where they act on the piston to output power in a power stroke.

### CROSS REFERENCE TO RELATED APPLICATION

This application is a continuation-in-part of, and claims priority under 35 U.S.C. Section 120 to, pending U.S. application Ser. No. 11/512,454, filed Aug. 29, 2006, which claims priority under 35 U.S.C. Section 119(e) to U.S. Provisional Appln. Ser. No. 60/712,068, filed Aug. 29, 2005, both of which are hereby expressly incorporated herein by reference.

### FIELD OF THE INVENTION

The present invention is directed to a combustion engine and more particularly to a flexible fuel capable reciprocating piston engine that is Brayton cycle, optionally modified Brayton cycle, operable.

### BACKGROUND OF THE INVENTION

FIG. 1 is an engine cycle diagram depicting basic operation of a conventional four cycle internal combustion spark ignition piston engine that operates under the Otto cycle. Otto engines are used in powered vehicles, such as automobiles, trucks, and off-road vehicles, as well as in power equipment, such as lawnmowers, construction equipment, generators, air compressors, and the like. Otto engines typically mix a combustible fuel with air that is ignited to produce power. While gasoline is the most common type of combustible fuel that is used in an Otto engine, other types of fuels, including ethanol, methanol, propane, methane, and the like, can also be used. A popular combustible fuel in use today in the United States is a mixture of ethanol and gasoline with the ratio of ethanol to gasoline varying anywhere from as little as a few percent ethanol to as much as 85% ethanol.

FIG. 1 depicts Otto engine operation for an exemplary engine having at least one cylinder with two valves (not shown) per cylinder and a reciprocable piston received in each cylinder defining a combustion chamber therein. At the beginning of cycle 1, the intake stroke, the piston is located at or near a top-dead-center (TDC) position. Typically, at least air alone or in combination with fuel is drawn through an open intake valve (not shown) into the combustion chamber due to movement of the piston away from TDC toward a bottom-dead-center (BDC) position. While fuel can be mixed with air before the mixture is drawn into the combustion chamber, such as where a carburetor or single-point fuel injection is used, the fuel can be delivered by way of multi-point fuel injection or direct injection as used in various gasoline and diesel engines.

Once the intake stroke is completed, the intake valve closes in preparation for compression of the air-fuel mixture in the combustion chamber during the compression stroke, cycle 2. During the compression stroke, the piston moves within the cylinder toward TDC compressing the air-fuel mixture within the combustion chamber due to piston movement decreasing the volume of the chamber.

After the air-fuel mixture is suitably compressed, the mixture is ignited, typically with a spark discharged by a spark plug, during the power stroke, cycle 3, such that combustion of the mixture produces combustion gases that rapidly expand in the chamber increasing the pressure within the chamber. This causes a corresponding force to be exerted against the piston, which ultimately displaces the piston back towards BDC. Piston displacement is translated by a connecting rod linking it to a crankshaft into rotary power engine output.

To discharge the combustion gases after completion of the power stroke, an exhaust valve is opened during the exhaust stroke, cycle 4, enabling the gases to be expelled out an exhaust, such as an exhaust manifold that typically communicates with a muffler. After the exhaust stroke is finished, the exhaust valve closes. Thereafter, these four cycles repeat themselves as needed for continuous engine operation.

FIG. 2 illustrates exemplary pressure-volume plots of such an Otto engine showing a work plot of work inputted during the intake and compression strokes, and a power plot depicting net power outputted during the power stroke. Each plot assumes an ideal thermodynamic cycle, an 8:1 compression ratio, a specific heat ratio of approximately 1.4 for air, and combustion gases are exhausted during the exhaust stroke until a pressure of about 3.5 atmospheres when the exhaust valve is opened. The area under the dashed or phantom line in the work plot represents the engine power outputted during the power stroke shown in the power plot and the area between the abscissa and the bottom curve of the power plot represents the inputted work.

While theoretical maximum efficiency for an Otto engine represented by the plots in FIG. 2 is greater than about 50%, in reality efficiency is far less. For example, it is not unusual for actual efficiencies to be less than half of theoretical in many Otto engine applications with typical maximum efficiency for an automobile engine being around 20-25%. Utility engines having a horsepower range of between 10 hp and 40 hp are usually even less efficient because they are often run rich to ensure consistent operation under a wide range of operating conditions.

While the Otto gasoline engine is the most popular engine in commercial use today, it is not without drawbacks and disadvantages. Most Otto engines cannot use more than one fuel without installation of expensive and sophisticated sensor systems that typically also require multi-point fuel injection to precisely meter fuel flow to accurately control air-fuel ratio. Similarly, almost all Otto engines require an expensive catalytic converter system to significantly reduce exhaust emissions. Additionally, Otto engines often operate at partial throttle where efficiency is even lower, often as low as about 10%.

These drawbacks and disadvantages are particularly true for utility engines that operate under the Otto cycle. These smaller engines typically have undesirably high exhaust emissions, typically in the range of 6-10 grams of hydrocarbons and nitrous oxides per horsepower hour, because it is not been presently found economical to equip them with catalytic converters. Because it is usually also not economical to equip such small engines with sophisticated mass flow sensors, engine control computers, fuel injection systems, gas recirculation systems, and the like, carbon monoxide emissions are usually also undesirably high because of the need to run rich to ensure consistent engine operation over a wide range of operating conditions.

Because of the need to keep utility engine costs economical, configuring these smaller utility engines to run rich to ensure consistent operation undesirably increases fuel consumption, which can range from 0.6 pounds per horsepower hour for wide open throttle up to as much as 1.3 pounds per horsepower hour at partial throttle. This also can cause combustion ignition and detonation problems with some engines also experiencing “after-bang” resulting from unburned fuel detonating when discharged from the engine during the exhaust stroke. Finally, such engines are usually loud, both during starting and during operation.

A Diesel engine operates somewhat similarly to an Otto engine except that it is a compression ignition engine where combustion in a Diesel engine takes place at constant volume rather than at constant pressure, which is possible with an Otto engine because it is a spark ignition engine. During the compression stroke of a Diesel engine, air in the combustion chamber is heated to a temperature high enough to ignite fuel injected into the combustion chamber without requiring any spark to incite ignition. While Diesel engines suffer from many of the same drawbacks and disadvantages as Otto engines, they also possess some unique drawbacks and disadvantages.

For example, while Diesel engines can use alternative fuels, fuel quality is especially critical because there is far less time to achieve vaporization and mixing with the compressed air to achieve compression ignition than there is for an Otto engine. Fuel must be injected right before the piston reaches the TDC position to ensure compression is great enough to achieve fuel ignition temperatures. If fuel quality is poor, such as if its Cetane rating is below 40, if it is not volatile enough, or if it has too high of viscosity, poor, no or incomplete combustion can result.

In addition, since fuel must be discharged into the combustion chamber at just the right time shortly before the piston reaches the TDC position to ensure the compressed air is hot enough to achieve compression ignition, more expensive fuel injectors and fuel injection control systems are required. Compressing air so it becomes hot enough to achieve compression ignition requires operation at a typical compression ratio of at least 14:1, which requires Diesel engines to be more strongly and heavily built. As a result, Diesel engines tend to cost significantly more such that very few utility engines are Diesel engines.

Another type of combustion engine most commonly associated with gas turbine engines is a Brayton engine that operates under the Brayton or Joule cycle. A Brayton cycle gas turbine engine typically includes a gas compressor, a burner or combustion chamber, and an expansion turbine where extracted work is outputted as power. Industrial gas turbines and jet engines are examples of such Brayton cycle engines.

However, before the Brayton cycle became so firmly associated with gas turbine engines, Brayton engines initially utilized a first reciprocating piston-cylinder arrangement as a compressor to compress air, a mixing chamber where fuel was mixed with compressed air where combustion of the air-fuel mixture took place, and another larger reciprocating piston-cylinder arrangement where expanded combustion gases acting on the piston provided power output. Some of the outputted power was inputted back into the engine as work to drive the compressor. Examples of Brayton-cycle piston-type combustion engines are disclosed in U.S. Pat. Nos. 5,894,729; 4,369,623; and 4,333,424. One other type of Brayton cycle piston-cylinder type engine is an Ericsson hot air engine, developed in the mid-1800's, which improved upon the original Brayton engine by including a recuperator or regenerator between the compressor and the expander that can increase engine efficiency.

While Brayton cycle gas turbine engines have enjoyed great commercial success, the Brayton cycle dual piston-cylinder engine counterpart to date has not. While a Brayton cycle dual piston-cylinder engine offers certain advantages over Otto and Diesel engines, significant hurdles have remained to date impeding their commercialization and acceptance. Therefore, improvements are desired that will facilitate commercialization and adoption of a piston-cylinder type engine which operates using a modified version of the Brayton cycle.

### SUMMARY OF THE INVENTION

The present invention is directed to a combustion engine that preferably is capable of operating under the Brayton cycle, or a modified version thereof, using conventional engine components thereby advantageously minimizing engine packaging requirements previously imposed by prior engines of such type. An engine constructed in accordance with the present invention preferably is configurable to operate under an engine operating cycle that includes at least a plurality of power strokes per engine operating cycle. Such an engine preferably utilizes a common piston cylinder arrangement to not only compress gas before discharging it for combustion, it also accepts gases undergoing expansion after combustion to extract power therefrom. In doing so, a combustion chamber external to the piston-cylinder arrangement is provided in fluid flow communication for accepting compressed gas discharged from the piston-cylinder arrangement, combusting the gas when mixed with fuel, and returning the mixture to the same piston-cylinder arrangement where expanding combustion gases act upon the piston during the power stroke to displace it outputting power from the engine as a result. Various preferred embodiments further include an compressed air tank or pressure vessel to temporarily store compressed air for later use in high power demand combustion situations or to provide pneumatic power to various accessories.

Where additional power can be extracted because additional gas expansion can be harnessed, a second power stroke preferably is performed so additional combustion gases can enter the piston-cylinder arrangement after the combusted gases from the first power stroke are exhausted. After the second power stroke is completed, the combusted gases are also exhausted. Such an engine cycle can be configured to perform two, four, six, eight or even more power strokes per complete engine operating cycle.

Valve control preferably helps enable efficient operation to be achieved by controlling valve timing to optimize compression, combustion, expansion and exhaust during engine operation. Also, various ones of the valves selectively route fluid flow through and between various flow paths of the engine, as desired. In addition, such an engine constructed in accordance with the invention is advantageously capable of changing compression ratio during engine operation without changing engine geometry. For example, compression ratio can be increased by changing or otherwise regulating valve timing and fuel flow without having to change cylinder volume. Other factors preferably also can be varied in doing so such as influencing the effective compression ratio by using forced induction methods and devices, storing and later utilizing compressed air, and/or other factors.

Such an engine preferably is configurable to sustain continuous or substantially continuous combustion in a combustion chamber that preferably includes an air-fuel mixer, combustor in which combustion takes place, and which can be configured to help facilitate expansion such as by cooperating with a piston-cylinder arrangement that previously compressed and discharged air to the combustion chamber. In a preferred combustion chamber embodiment, the combustion chamber includes a combustor encompassed by a mixer that preferably absorbs heat lost from combustion using heat regeneration to increase efficiency.

An engine can have a plurality of piston-cylinder arrangements, each of which includes a piston reciprocable received in a cylinder. The piston preferably is connected by a connecting rod to an output, such as a crankshaft, out which power is transmitted from the engine. The cylinder preferably is capped by a cylinder head that includes at least a plurality, e.g., three or more, of valves that help regulate and coordinate gas flow during engine operation. The piston, cylinder and cylinder head define a working fluid chamber which not only compresses air before discharging it to the combustion chamber, it thereafter accepts combustion gases from the combustion chamber in extracting work therefrom due to the piston being displaced by the force of the combustion gases acting on it. Two, three, four or more piston-cylinder arrangements can be employed in an engine of the invention that preferably is configured to operate using the Brayton cycle, or a modified version thereof, having at least two power strokes using a common piston-cylinder arrangement.

One valve used to control gas and/or fluid flow during engine operation includes an intake valve that allows air to be drawn into the cylinder when charging it with air during the intake stroke. Another valve is a compressed air discharge valve that opens to permit compressed gas to be discharged from the piston-cylinder arrangement into the combustion chamber during the compression stroke. A still another valve is a combustion gas intake valve that opens to accept combustion gases undergoing expansion that are being discharged from the combustion chamber during a first power stroke. When the first power stroke is completed, an exhaust valve opens during an exhaust stroke to allow combusted gases in the cylinder to be exhausted.

A second power stroke is performed, preferably after the exhaust stroke, to permit additional combustion gas expansion to be captured and turned into work. This preferably occurs by discharging additional combustion gases from the combustion chamber into a piston-cylinder arrangement of substantially the same volume as the piston-cylinder arrangement where compression was performed during the compression stroke. In an embodiment, they are one and the same. In another preferred embodiment, two such piston-cylinder arrangements are used to carry out the first and second power strokes substantially simultaneously. Where this is done, one of the piston-cylinder arrangements is the piston-cylinder arrangement where compression during the compression stroke was performed.

In another preferred implementation, the first and second power strokes occur one after another with at least one exhaust stroke occurring after each power stroke. Each such piston-cylinder arrangement preferably has substantially the same maximum volume as that which performed compression during the compression stroke. In some embodiments, the same piston-cylinder arrangement that performed air compression also performs each power stroke in succession or sequence.

Timing of valve opening and closing of at least one and preferably a plurality of the intake valve, the compressed air discharge valve, the combustion gas intake valve and the exhaust valve is configured to enable compression ratio to be changed during engine operation without changing piston-cylinder volume, including maximum volume, during engine operation. Fuel flow and air mass flow can also be varied and controlled to help do so.

Objects, features and advantages include at least one of the following: providing a combustion engine of piston-type construction that is capable of using present day engine components while still being of compact construction where are cylinders are sized the same; providing a Brayton cycle or modified Brayton cycle piston-type combustion engine that is efficient and fuel-type versatile; providing a combustion engine that is efficient over a wide range of operating conditions; providing a combustion engine that runs lean by keeping fuel-air mixture less than stoichiometric; providing a combustion engine that can be more easily started at a lower compression ratio because compression ratio can be increased during operation; providing a combustion engine that is quiet because combustion preferably is continuous and pressure pulses are minimized; providing a combustion engine of Brayton cycle or modified Brayton cycle piston-type construction that can be configured for utility engine use; and providing a combustion engine of simple, quick, and inexpensive manufacture that is durable, long-lasting, and easy-to-use, and providing a method of making, using, operating and assembling a combustion engine that is simple to implement, quick, labor-efficient, economical, and which requires relatively simple skills to perform and operate.

Various features and advantages of the present invention will also be made apparent from the following detailed description and the drawings.

### BRIEF DESCRIPTION OF THE DRAWINGS

Preferred exemplary embodiments of the invention are illustrated in the accompanying drawings in which like reference numerals represent like parts throughout and in which:

FIG. 1 is an engine operation cycle diagram for a prior art Otto cycle, spark ignition, internal combustion engine;

FIG. 2 illustrates work input and power output pressure volume plots for a prior art Otto cycle, spark ignition, internal combustion engine;

FIG. 3A is a schematic diagram of a Brayton cycle or modified Brayton cycle, piston-type combustion engine constructed in accordance with the present invention.

FIG. 3B is a schematic diagram of the engine of FIG. 3A including a pressure vessel and a pressure multiplier.

FIG. 3C is a schematic diagram of the engine of FIG. 3B including a turbocharger as a forced induction mechanism.

FIG. 3D FIG. 3C is a schematic diagram of the engine of FIG. 3B including a supercharger as a forced induction mechanism.

FIG. 4 is a schematic diagram depicting an embodiment of the engine of FIG. 3B in more detail;

FIG. 5 is cross sectional view of take through section line 5-5 of the cylinder head embodiment depicted in FIG. 4;

FIG. 6 is a side elevation view of a first embodiment of a poppet valve that opens in the direction of pressure and flow;

FIG. 7 is a side elevation view of a second embodiment of a poppet valve that closes in the direction of pressure and flow;

FIG. 8 is a side elevation view of a pressure-actuated valve;

FIG. 9 is a front elevation view of a variable valve;

FIG. 10 is an engine cycle diagram depicting six cycle engine operation;

FIG. 11 is a valve operation diagram for six cycle engine operation;

FIG. 12 depicts a first series of pressure-volume plots illustrating low power engine operation;

FIG. 13 depicts a second series of pressure-volume plots illustrating moderate-low power engine operation;

FIG. 14 depicts a first series of pressure-volume plots illustrating moderate power engine operation;

FIG. 15 depicts a first series of pressure-volume plots illustrating high power engine operation;

FIG. 16 is a schematic diagram of a second embodiment of a Brayton cycle or modified Brayton cycle combustion engine constructed in accordance with the present invention; and

FIG. 17 is a schematic diagram of another embodiment of a Brayton cycle or modified Brayton cycle combustion engine constructed in accordance with the present invention.

FIG. 18 is a schematic diagram of yet another embodiment of a Brayton cycle or modified Brayton cycle combustion engine constructed in accordance with the present invention.

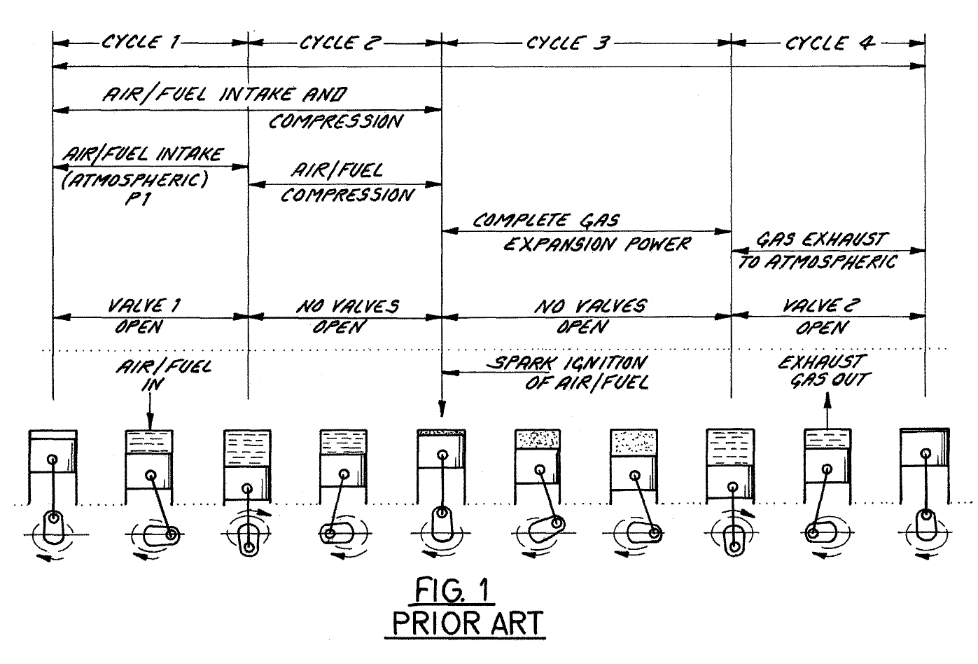

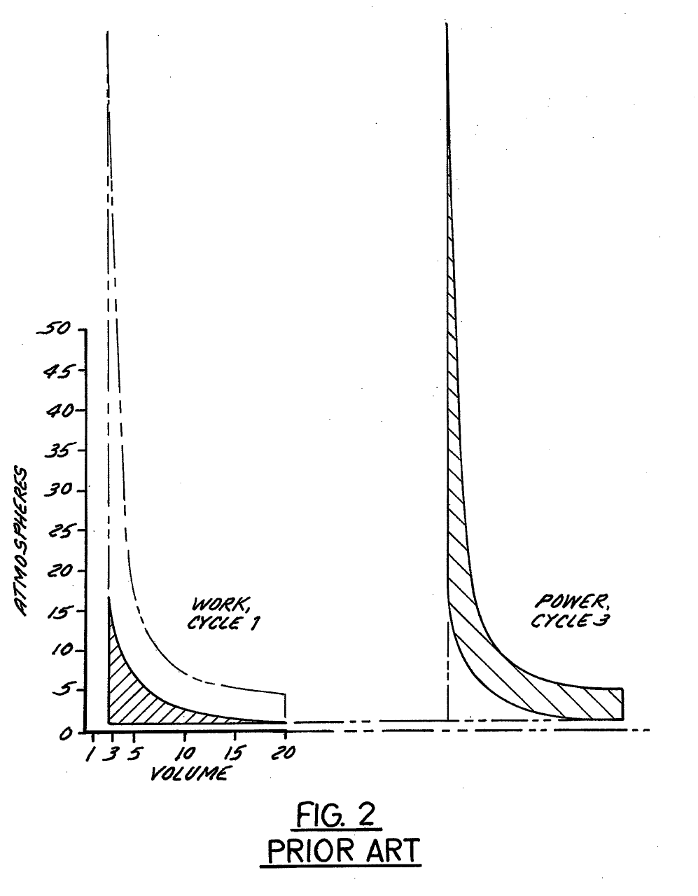

Before explaining embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF AT LEAST ONE EMBODIMENT

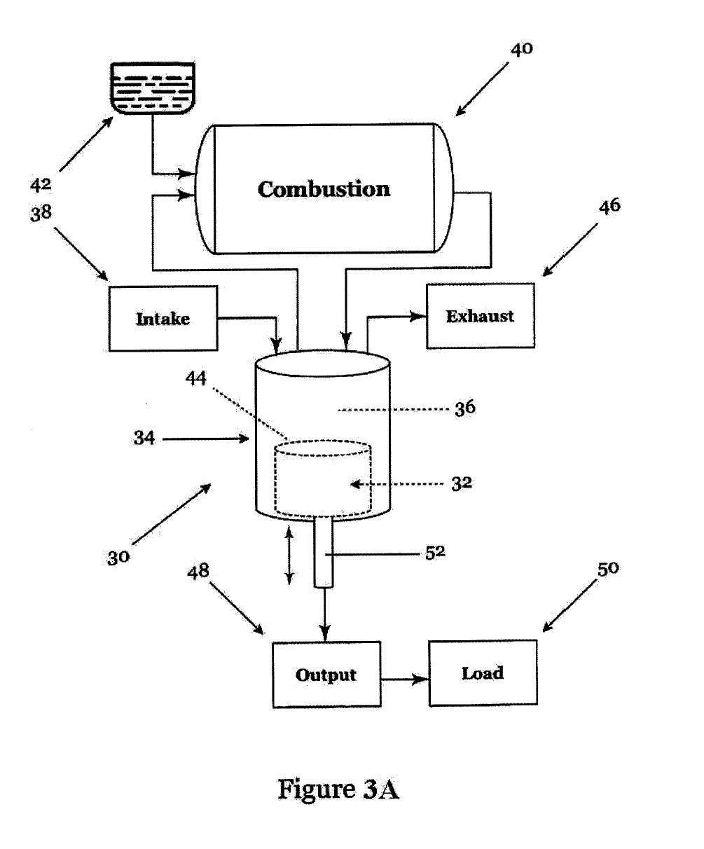

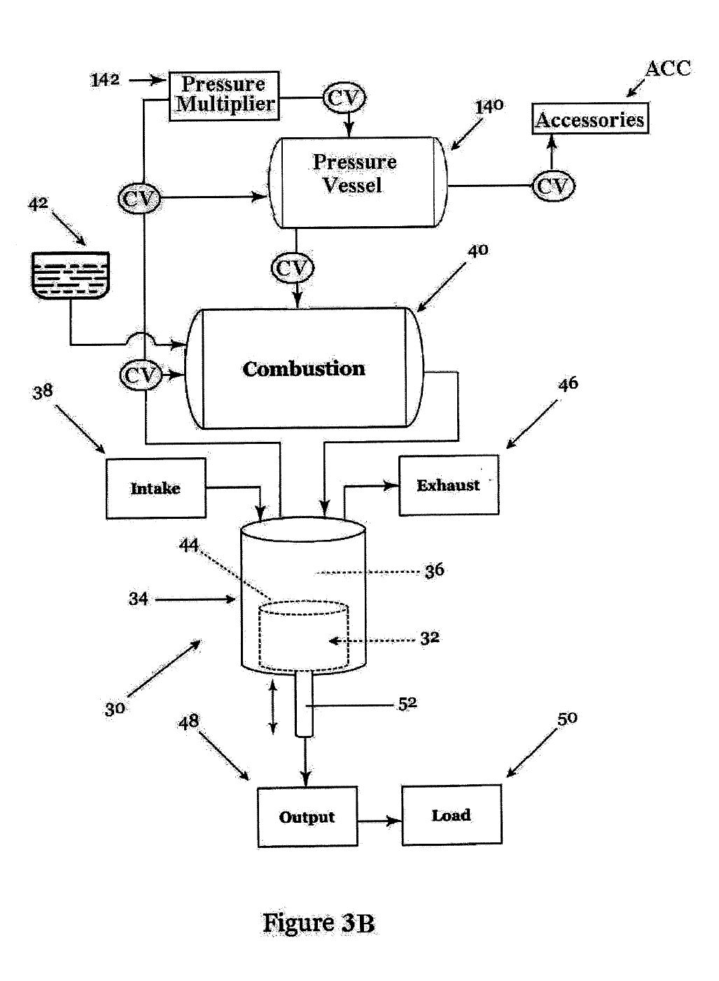

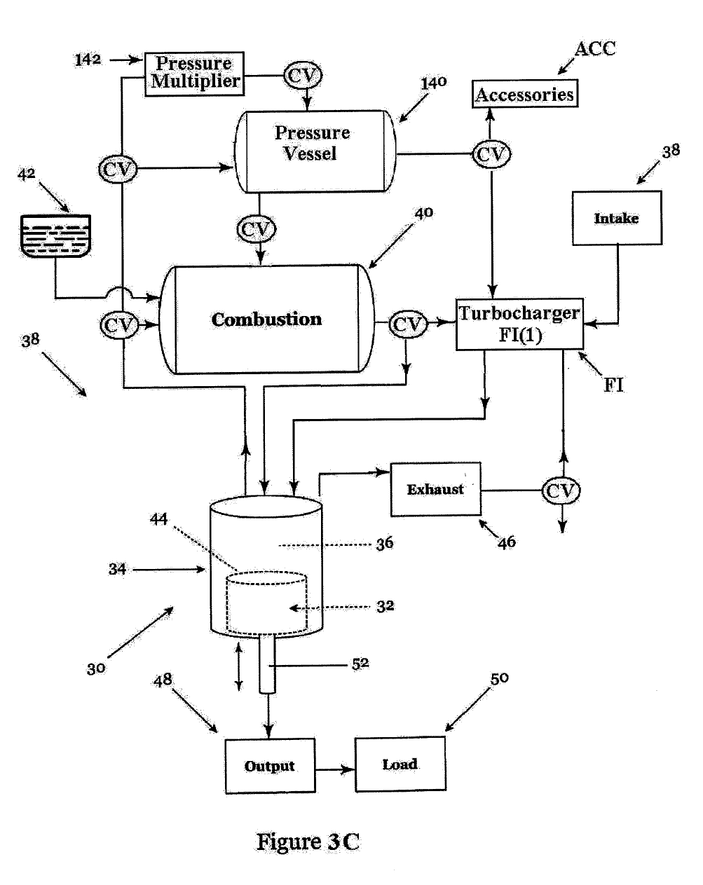

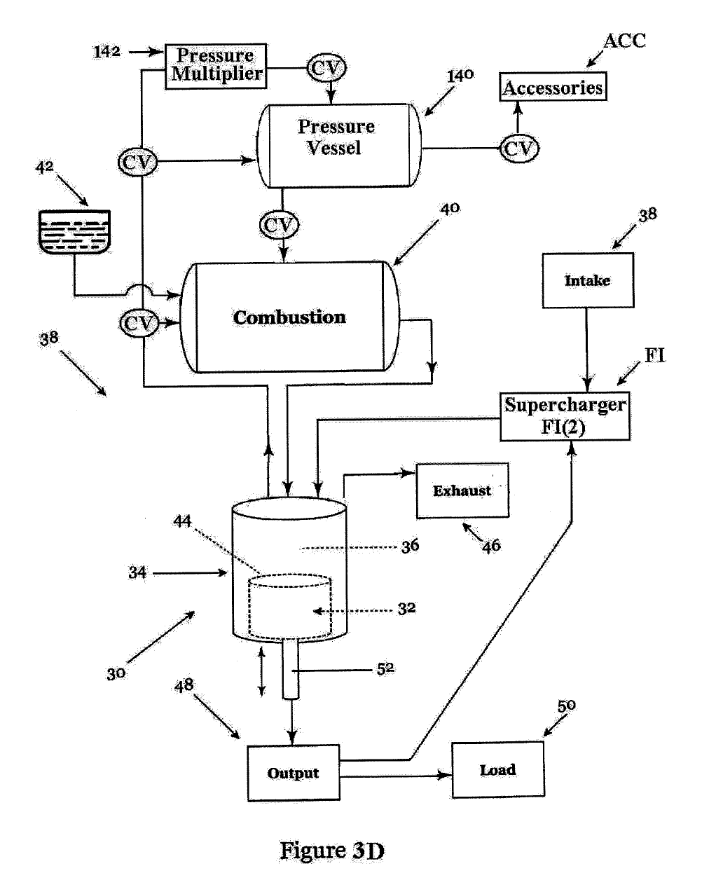

Each of FIGS. 3A, 3B, 3C, and 3D, illustrates a schematic depicting an embodiment of a Brayton cycle or modified Brayton cycle piston-type combustion engine 30 of the present invention that includes a reciprocable piston 32 received in a cylinder 34 defining a working fluid chamber 36 in which fluid, preferably air, drawn into the chamber 36 from an intake 38, e.g., intake manifold, during an intake stroke is compressed during a compression stroke before the compressed fluid is delivered to a combustion chamber 40.

Generally, in the embodiments shown in FIGS. 3A, 3B, 3C, and 3D, fuel from a fuel source 42, such as a fuel tank or the like, is delivered to the combustion chamber 40 where it is mixed with compressed fluid in the chamber 40. Combustion occurs causing the mixture to expand preferably at substantially constant pressure before it is directed to the same working fluid chamber 36 that previously compressed the fluid during the compression stroke. Expansion resulting from combustion increases pressure in the working fluid chamber 36 causing a corresponding force to be applied against a head 44 (shown in phantom) of the piston 32. This applied force displaces the piston 32 causing work to be performed.

Thereafter, the combusted mixture is discharged from the working fluid chamber 36 via an exhaust 46, e.g., exhaust manifold, during an exhaust stroke. Piston displacement preferably facilitates discharge of the combusted mixture. In some embodiments, combusted mixture is discharged via the exhaust 46 to the environment. If desired, the exhaust 46 can include or communicate with a muffler (not shown) or the like before reaching the environment.

As previously discussed, work is performed on the piston head 44 during the power stroke due to combustion mixture expansion displacing the piston 32. Piston displacement translates this work into engine power output. For example, in the preferred embodiment shown in FIG. 3A, the piston 32 is coupled to an output 48 that is driven by displacement of the piston 32 during the power stroke. While the output 48 is preferably connected to a load 50, the load 50 can be directly coupled to the piston 32, if desired.

In one preferred embodiment, the piston 32 is coupled to the output 48 by an elongate connecting rod 52 that extends outwardly from the piston head 44. For example, where the output 48 is or includes an output shaft (not shown), such as a rotary crankshaft or the like, the connecting rod 52 is pivotally connected at or adjacent one end to the output shaft preferably by a coupling (not shown) and bearing arrangement (also not shown) between the coupling and shaft. The rod 52 preferably is also pivotally connected in the same or like manner at its other end to the piston head 44.

The output 48 preferably is connected to a load 50. For example, where the output 48 is an output shaft, such as a crankshaft, it can be connected to a load 50, such as a wheel, blade, cutter, head, chain, tines, propeller, pump, alternator, wheel(s), track(s), or the like. If desired, a drivetrain (not shown) can be provided as part of the output 48 or between the output 48 and load 50, if desired. Where a drivetrain is employed, it preferably includes one or more of the following: a transmission, e.g., gearbox, a clutch, a hydrodynamic coupling, a torque converter, a differential, and/or a control system.

Where additional work can be extracted from expanding combustion mixture remaining in the combustion chamber 40, a second power stroke preferably is implemented after the exhaust stroke. Of course, a second exhaust stroke preferably also is then implemented to discharge the combusted mixture from the working fluid chamber 36 when the second power stroke is finished. Whether four or six stroke or six cycle operation is contemplated, the aforementioned strokes or cycles repeat themselves in the same order as described above over and over again during engine operation typically until engine operation is stopped. Stopping engine operation can be accomplished by shutting the engine off, stopping fuel flow to the combustion chamber 40, ceasing ignition where ignition is required to sustain combustion, or in another manner.

The engine 30 can be readily switched during operation between four cycle, six cycle, or between more cycles as desired. As one example, in some embodiments, the engine 30 is adapted to operate primarily in either four cycle or six cycle mode. Since power output is a function of how much air, and thus combustion promoting oxygen, is present during a combustion period, it follows that four cycle operation of engine 30 yields relatively greater power density whilst six cycle operation yields relatively greater efficiency. Accordingly, during use, when greater power is demanded or otherwise required, engine 30 momentarily switches from 6 cycle to four cycle operation, thereby satisfying the temporary power need. Notwithstanding, in some embodiments the high efficiency i.e. six or more cycle functionality of engine 30 is effectively locked out, whereby engine 30 is then configured for high power output and/or improved flex-fuel capability at low emission output levels.

Referring now to FIGS. 3B, 3C, and 3D, in some embodiments, the Brayton cycle or modified Brayton cycle piston-type combustion engine 30 is further adapted and configured to temporarily store energy. As illustrate, engine 30 stores energy for later use, as needed or desired, in the form of a captured or stored compressible fluid such as air, which is stored under pressure.

Such embodiments include a tank or storage enclosure, e.g. pressure vessel 140, is in fluid communication with remainder of engine 30, preferably fluidly communicating with cylinder 34 and combustion chamber 40. Pressure vessel 140 is, for example, an air compressor tank, a compressed air storage tank, or other vessel which suitably holds a desired volume of gas under the desired maximum storage pressure. Correspondingly, pressure vessel 140 preferably includes a safety relieve valve which vents, lets off, or otherwise releases, some of the pressurized air from the pressure vessel 140 in response to exceedingly high vessel pressures. Preferably, any released volume of air is released into yet another pressure vessel (not illustrated), such that the released or vented pressurized air can be later utilized, as desired.

In other words, pressure vessel 140 stores compressed air, then releases it as required for later utilization by engine 30. As desired, the pressurized air of pressure vessel 140 is released into combustion chamber 40 in order to, for example, provide bursts of increased power output, explained in greater detail elsewhere herein. Also, as desired, the pressurized air of pressure vessel 140 can be released to pneumatically drive or power various engine accessories, for example accessories “ACC.” Optionally, accessories ACC are pneumatically driven by other engine operational gasses such as combustion gasses, exhaust gasses, and others, be it alone, in combinations of such other operational gasses, or in combination with the compressed air of pressure vessel 140.

Accessories ACC include any of a variety of engine or vehicle accessories which are typically mechanically driven, whether by belt or otherwise. Thus, accessories ACC include, but are not limited to, alternators, power steering pumps, air conditioning compressors, water pumps, and/or others.

Accessories ACC are substantially analogues of their conventional mechanically driven counterparts, with the main dissimilarity at the respective drive pulley assemblies. Thus, in lieu of a conventional belt-driven pulley, each of the accessories ACC includes e.g. a rotary-vane device. Such rotary-vane devices suitably convert the energy of the compressed air, of pressure vessel 140, into rotary motion of the rotating components of the respective accessories ACC. In such a manner, it couples fluid supplied from pressure vessel 140 to one or more accessories ACC and serves as an accessory drive that is driven by the fluid and that drives one or more accessories ACC.

In some embodiments, the pressurized air which exits cylinder 34 is compressed yet again, at least one more time, before storage in pressure vessel 140. Pressure multiplier 142 embodies a suitable device for further compressing the compressed air which is ultimately stored in pressure vessel 140. Pressure multiplier 142 is an air compressor, preferably an air-driven air compressor, which intakes the compressed air delivered from cylinder 34, further compresses the air, and then outputs the further compressed air into pressure vessel 140, for storage therein.

In other embodiments, the air which enters cylinder 34 for compression therein is compressed for a first time before entering the cylinder 34. In other words, referring specifically to the embodiments of FIGS. 3C and 3D, in some implementations, the air intake of engine 30 is not naturally aspirated, but rather includes a forced induction system such as forced induction mechanism “FI.” Various suitable forced induction mechanisms are illustrated schematically in FIGS. 3C and 3D as turbo charger FI(1) and supercharger FI(2), respectively.

Turbocharger FI(1) has a turbine side and a compressor side. The turbine side includes a turbine wheel rotatably accommodated within a turbine housing. The compressor side includes a compressor wheel rotatably accommodated within a compressor housing. A common shaft coaxially connects the turbine wheel and the compressor wheel, such that the two wheels rotate in unison with each other. The turbine side of the turbocharger accepts fluid flow from a variety of sources, any of which can rotate the turbine wheel and correspondingly the compressor wheel also.

As illustrated in FIG. 3C, any one, or combinations of any, of (i) the combustion gases exhausted from combustion chamber 40, stored compressed air from pressure vessel 140, and/or exhaust gases 46, pass over and push vanes of the turbine wheel, and thereby rotating the turbine wheel, and correspondingly rotating the compressor wheel. As the compressor wheel rotates, it intakes ambient air, compresses it, then discharges the compresses air into the intake of cylinder 34 for yet further compression therein.

Accordingly, since multiple air flow sources can pneumatically power the turbocharger, the particular volume and velocity of air which enters the turbine side of the turbo charger is influenced by which sources provide airflow into the turbine side at that particular time. As one example, under relatively low engine power conditions, the velocity of the combustion gases leaving the combustion chamber 34 is relatively low. Therefore, under such operating conditions, the combustion gases enter the turbine side of the turbocharger relatively slowly and thus spin the turbine wheel relatively slowly, creating little, if any boost pressure in the compressor side.

If the user desires a quick increase of engine power output, in addition to the typical operational response to e.g. an increased throttle input, pressurized air is released from storage in pressure vessel 140 into combustion chamber 40, as is a corresponding volume of additional fuel. The introduction of pressurized air into combustion chamber 40 increases the pressure within the chamber and the pressure and volume of combustion gas discharged from the combustion chamber 40. Correspondingly, the increased volume and pressure of air flowing from the combustion chamber 40 increases the rate of rotational velocity change of the turbine wheel. Stated another way, releasing pressurized air from pressure vessel 140, into combustion chamber 40, reduces the turbocharger spool-up time and thus mitigates episodes of turbo-lag. Optionally, compressed air from pressure vessel 140 is discharged into the turbine side of turbocharger FI(1) to reduce the turbo spool-up time, in addition to or in lieu of discharging into combustion chamber 40.

Referring now to FIG. 3D, in some embodiments, the forced induction system is a supercharger FI(2). Supercharger FI(2) is mechanically, belt, driven by engine 30. The supercharger FI(2) can be, for example, a centrifugal supercharger or screw or roots type, as desired. Like turbocharger FI(1), supercharger FI(2) compresses ambient air and discharges the compressed air into cylinder 34 for further compression therein.

In embodiments of engine 30 which include pressure vessel 140, pressure multiplier 142, and/or forced induction mechanisms FI, the complete assemblage also includes various valves or fluid gates, e.g. control valves CV (FIGS. 3B, 3C, and 3D). The control valves CV, explained in greater detail elsewhere herein, are adapted and configured to control the particular flow pattern of, for example, pressurized air at any particular time and based at least in part on engine operating conditions.

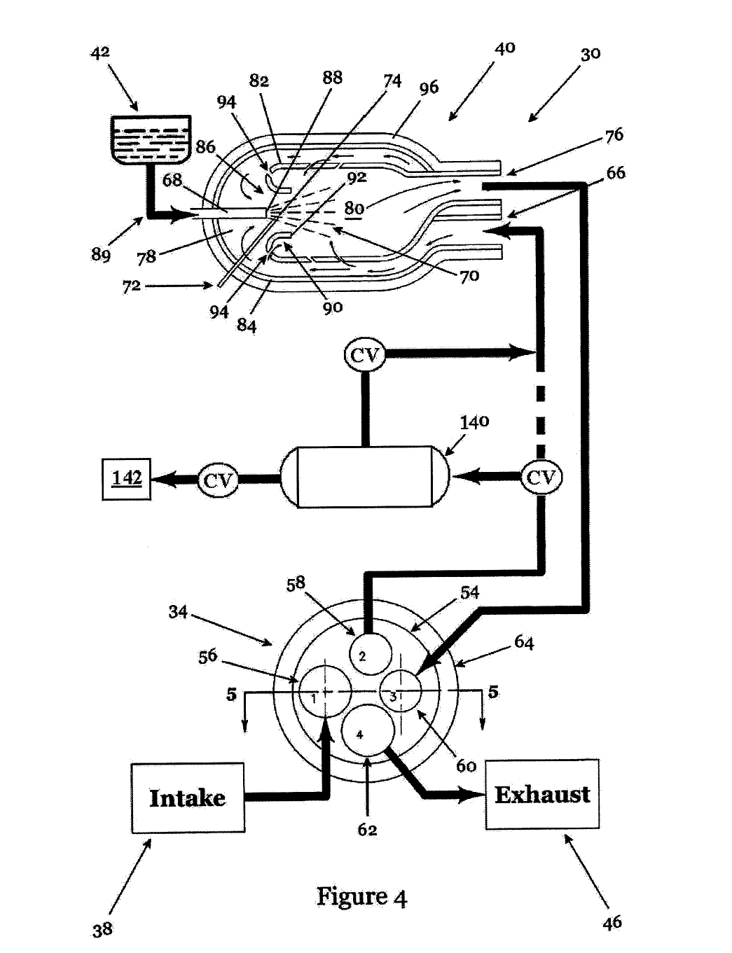

FIG. 4 illustrates an exemplary embodiment of a Brayton cycle or modified Brayton cycle piston-type combustion engine 30 constructed and configured to operate in accordance with the present invention. The engine 30 includes a cylinder head 54 that defines a top wall of the cylinder 34 and has at least four valves 56, 58, 60 and 62 for enabling fluid flow into and out of the working fluid chamber 36. The cylinder head 54, a sidewall 64 of the cylinder 34, and the top of the piston head 44 preferably define the working fluid chamber 36. During engine operation, the volume of the chamber 36 varies relative to displacement of the piston 32. For example, when the head 44 of the piston 32 is located at top-dead-center (TDC), chamber volume is at a minimum. When the head 44 of the piston 32 is located at bottom-dead-center (BDC), chamber volume is at a maximum.

For the purposes of explaining the construction and operation of the engine embodiment depicted in FIG. 4, air will be used as an exemplary fluid drawn into the cylinder 34 during the intake stroke and gasoline will be used as an exemplary fuel mixed with the air in preparation for combustion and expansion during the power stroke. This is because an engine constructed in accordance with the present invention contemplates being configured to be able to use such a preferred air-fuel combination.

It is an advantage that an engine constructed in accordance with the present invention can operate using a wide range of fuels as well as fluids with which fuel can be mixed before combustion. In some methods of operation, one such fluid which an engine constructed and configured in accordance with the invention is an oxygen containing gas that preferably is air or the like. As further evidence of the versatility and flexibility of an engine constructed in accordance with the invention, fuels including gasoline, diesel fuel, alcohol, e.g., methyl and ethyl alcohol, methane, propane including LPG, hydrogen, seed oil(s), cooking oil(s), as well as other flammable fluids can be used. Fuel mixtures including E85, E20, and other mixtures of two or more such fuels also advantageously be used.

In some embodiments, air is drawn into the cylinder 34, by vacuum (FIGS. 3A, 3B), as the piston 32 moves toward the BDC position. To enable air to be drawn into the cylinder 34, an air intake valve 56, valve 1 in FIG. 4, is opened and remains open for enough time for a sufficient volume of air to enter the cylinder 34. In embodiments utilizing forced induction FI (FIGS. 3C and 3D), in addition to cylinder vacuum created by drawing piston 32 toward the BDC position, the pressurized or boosted air from the forced induction mechanism FI forces its way into cylinder 34, by way of the pressure differential defined between cylinder 34 and the forced induction mechanism FI. After this occurs the air intake valve 56 closes.

In one preferred and exemplary method of operation of the engine 30 depicted in FIG. 4, the air intake valve 56 (valve 1) closes at or near when the piston 32 reaches the BDC position. In another preferred and exemplary implementation, the valve 56 is closed shortly after the piston 32 passes beyond the BDC position. In either case, after the valve 56 closes and the piston 32 begins moving toward the TDC position, cylinder volume begins to decrease thereby compressing the air in the cylinder 34 during the compression stroke. Volume steadily decreases until the piston 32 approaches or even reaches the TDC position such that maximum compression is reached. All of the valves 56, 58, 60 and 62 preferably remain closed during the compression stroke.

In one embodiment of engine construction, the piston 32, cylinder 34, and cylinder head 54 are chosen so the change in cylinder volume during the compression stroke produces a compression ratio of at least 3:1 and preferably at least about 8:1 or higher. In other embodiments, the cylinder volume differential between minimum and maximum cylinder volumes is selected to provide a compression ratio of at least 12:1. It is another advantage of a Brayton cycle or modified Brayton cycle piston-type combustion engine constructed in accordance with the invention that it can be operated at such a wide range of compression ratios. Also, forced induction embodiments enable yet further modulation of the effective compression ratio by controlling boost pressure at the turbocharger FI(1) or supercharger FI(2). Being able to do so enables compression ratio to be varied in accordance with: engine operating requirements including power and efficiency requirements, fuel type, ambient conditions, and the like.

In an exemplary method of operation, the engine 30 is initially operated at a compression ratio of less than 8:1 to reduce the power required to start the engine. Doing so preferably also enables use of a method of starting the engine 30 that is different and advantageously quieter than traditional flywheel ring gear and start pinion internal combustion engine starting arrangements, which have a tendency to be noisy during use. Thereafter, compression ratio preferably is increased to increase not only engine efficiency but engine power output as well. Accordingly, in embodiments utilizing forced induction FI mechanisms FI (FIGS. 3C and 3D), at initial startup condition, a respective control valve CV disengages the fluid connection between forced induction mechanism FI and the cylinder intake, whereby the engine retains a generally lower effective compression ratio at startup.

Optionally, at startup, any boost pressure created by the forced induction mechanism FI is vented off or directed to pressure vessel 140 by way of a control valve CV for storage and later use, whilst not undesirably increasing the effective compression ratio at initial startup. Once the engine 30 transmitions from the initial startup phase to the operational phase, the respective control valve CV redirects the boosted, pressurized, air output from the forced induction mechanism FI to the cylinder 34 intake for further compression during the compression stroke.

When the compression stroke is completed, a compressed air discharge valve 58, valve 2, is opened permitting compressed air in the cylinder 34 to flow from the cylinder into either (i) the combustion chamber 40 and/or (ii) the pressure vessel 140, directly or by way of further compression via pressure multiplier 142. The valve 58 preferably remains open long enough for a sufficient or desired volume of compressed air to be discharged into the chamber 40 or vessel 140. In some embodiments, when the compression stroke is completed and/or in the process of being carried out, compression of air preferably occurs at a certain constant pressure for at least part of the compression stroke. In some implementations, air compression preferably occurs at substantially constant pressure for part of the compression stroke near the end of the compression stroke.

To minimize heat loss, any conduit or piping through which compressed air passes before reaching the combustion chamber 40 preferably is constructed of a thermally insulating material and/or insulated with a thermally insulating material. Emissive coatings, formulations, and the like, heat reflecting and heat reflective arrangements, and other heat loss reducing arrangements can also be employed in a manner that helps minimize compressed air heat loss to help maximize engine efficiency. Depending on the temperature of exhaust gases being discharged from the engine, exhaust heat, e.g. regenerative heating, can be extracted and used to further heat compressed air entering the combustion chamber 40 to help increase efficiency. It also can be extracted and used to heat the contents of the chamber 40, including compressed air entering the chamber 40.

While the engine 30 shown in FIG. 4 depicts a combustion chamber 40 located some distance away from the cylinder 34, the chamber 40 preferably is located as close to the cylinder 34 as possible to minimize the amount of work in the form of pumping losses that occurs during discharge of compressed air from the cylinder 32 into the chamber 40. For example, in one embodiment that is not shown in the drawing figures, the combustion chamber is formed as part of the cylinder head. Such a cylinder head can have the combustion chamber integrally formed in it, such as by molding, casting or using another forming process that can require at least some machining or the like.

As is shown in FIG. 4, compressed air from the cylinder 34 flows through the open discharge valve 58 (valve 2), through control valve CV which directs it into one or more of (i) pressure multiplier 142, (ii) pressure vessel 140, or (iii) an inlet 66 in the combustion chamber 40, until pressure equalization occurs, and/or the valve 58 or CV closes. Preferably, the dwell time or time the valve 58 is open is selected to help keep the pressure of the compressed air entering the vessel 140 or chamber 40 at or near the maximum pressure it was compressed during the compression stroke.

In one method of operation, the valve 58 preferably is closed no later than when the piston 32 reaches TDC. In another method implementation, the valve 58 is closed shortly after the piston 32 reaches TDC and begins moving back toward BDC. Routine testing and experimentation can also be used in determining compressed air discharge valve dwell time.

Regardless of the particular route the air takes to enter combustion chamber 40, be it directly from cylinder 34 or via pressure vessel 140, the temperate and/or pressure of the air charger which will be used for combustion is monitored before entering, i.e. upstream from, the combustion chamber 40. It is particularly desirable to monitor the temperature and/or pressure of such air charge in forced induction FI embodiments. This is because pressure and temperature are functions of each other, whereby relatively greater air pressures associated with the forced induction FI correspond to relatively greater air temperatures during use.

When the temperature approaches non-desired levels, various evaporative cooling techniques and components can be employed. Exemplary evaporative cooling techniques suitable for use with engine 30 include water injection, alcohol (preferably methanol) injection, and propane injection. In all of these techniques, the fluid, namely water, methanol, or propane, is injected into the air charge in a liquid phase. The relatively high temperature of the air charge evaporates the liquid water, methanol, or propane, converting it into its gaseous phase. Accordingly, heat energy of the air charge is consumed in evaporating the liquid, whereby the temperature of the air charge is reduced to desired levels suitable for and prior to entering combustion chamber 40. In embodiments utilizing water injection, the water can be sourced from exhaust condensation, mitigating the need to replenish the injection water.

The compressed air entering the combustion chamber 40 flows toward a fuel port 68, from which fuel 70 from the fuel tank 42 is delivered into the chamber 40. Fuel 70 preferably is expelled from the port 68 outwardly into the combustion chamber 40 in a manner that facilitates mixing of the fuel 70 with the compressed air flowing through the chamber 40 in the vicinity of the port 68. In forced induction embodiments, as the boost pressure increases, the volume of fuel 70 expelled from port 68 and into combustion chamber 40 is adjusted.

The fuel port 68 shown in FIG. 4 is of tubular and elongate construction. The port is in fluid-flow communication with the fuel tank 42, from which fuel 70 is supplied. The fuel system depicted in FIG. 4 preferably is a pressurized fuel delivery system 89. To help ensure fuel pressure is greater than the pressure within the combustion chamber 40, a fuel pump, such as a diaphragm pump, a turbine pump, or a gerotor pump, can be used to draw fuel 70 from the tank and discharge it under sufficient pressure from the fuel port 68. Such a fuel delivery system preferably delivers fuel 70 out the port 68 at a pressure substantially greater than the gas pressure within the combustor 80 to help ensure consistent fuel flow and good control of fuel flow. While a simple fuel port tube or conduit like that shown in FIG. 4 can be used, a fuel injector or other type of fuel delivery device, including one that enable fuel metering to be performed, can also be used in place of or in addition to the fuel port 68.

At or after fuel mixes with the air, the air-fuel mixture combusts creating combustion gases that rapidly expand causing a corresponding rise in pressure and/or volume at that pressure. An igniter 72 in the vicinity of the air-fuel mixture can be used to ignite the mixture to cause it to combust. Where combustion is or tends to be self-sustaining, such as in embodiment that operate at compression ratios which are high enough to produce self-ignition, the igniter 72 is only used as needed to ensure combustion occurs in the desired manner. For example, where combustion is continuous, the igniter 72 may only be needed to initially ignite the air-fuel mixture with combustion continuing onward thereafter until engine operation is stopped. In another embodiment, a sensor (not shown) is employed to help monitor combustion such that the igniter 72 is only operated as needed to restart combustion, to improve combustion, and/or to otherwise facilitate or optimize combustion.

In some embodiments, the igniter 72 is a spark generating device, such as a spark plug or the like. In another embodiment, the igniter 72 can be a device that is heated to a temperature sufficient to cause ignition of the air-fuel mixture. In a still another embodiment, a plasma generator can be employed. Of course, other types of igniters and other igniter configurations can be used.

While the igniter 72 is depicted as being positioned with its ignition end 74 downstream and in the path of fuel 70 expelled from the fuel port 68, the portion of the igniter 72 that effects ignition can be located elsewhere. For example, the ignition end 74 of an igniter 72 that is configured to discharge a spark can be positioned further downstream of the fuel port, such as preferably adjacent an end of the combustion chamber 40 opposite the fuel port 68.

During combustion, a combustion gas intake valve 60, valve 3, is opened so the expanding combustion gases can exit from an outlet 76 of the combustion chamber 40 and enter either the turbine side of turbocharger FI(1) or the cylinder 34. Regardless of whether the combustion gases flow directly in to cylinder 34 or pass through the turbocharger FI(1) first, the gases that enter cylinder 34 drive the piston 32 toward BDC causing power to be outputted. Preferably, opening of the combustion gas intake valve 60 (valve 3) is timed relative to the closing of the compressed air discharge valve 58 (valve 2) to optimize engine power output. For example, the combustion gas intake valve 60 preferably opens as quickly as possible after the compressed air discharge valve 58 closes. In one engine operating configuration, the combustion gas intake valve 60 opens immediately after the compressed air discharge valve 58 closes. In another configuration, the gas intake valve 60 opens substantially simultaneously with the closing of the compressed air discharge valve 58.

The combustion chamber 40 depicted in FIG. 4 includes an annular mixing section 78 that encompasses or encircles at least a substantial part of an internal combustor 80 where the air-fuel mixture is ignited causing combustion to occur. A common sidewall 82 that separates the mixer 78 from the combustor 80 preferably is of perforate construction or the like to facilitate not only mixing but also improve completeness of combustion. Placement of the mixer 78 so it surrounds the combustor 80 improves efficiency because at least a substantial amount of heat lost from the combustor 80 is beneficially transferred to compressed air in the mixer 78 as a result thereby providing heat recovery.

The mixer 78 is further defined by a sidewall 84 located outwardly of the perforate common sidewall 82. The outer sidewall 84 is of non-perforate sealed construction to maintain the pressure of entering compressed air as well as that of combustion gases undergoing expansion. The outer sidewall 84 preferably is configured to impart an oblong shape to the mixer 78 defining a sleeve with the common sidewall 82 that surrounds the combustor 80. The common sidewall 82 has an opening at an end opposite the inlet and outlet of the combustion chamber 40 that defines a combustor mouth 86 that helps channel compressed air flow along and around a discharge opening 88 of the fuel port 68 out which fuel 70 flows during combustion chamber operation. The common sidewall 82 preferably includes an annular curved lip 90 encompassing the mouth 86 that has an outer edge 92 extending generally axially toward the inlet 66 and outlet 76 of the combustion chamber 40.

This arrangement helps facilitate mixing by directing compressed air flow entering the mouth 86 of the combustor 80 so it converges at a point at and/or in front of the fuel port discharge opening 88. In addition, depending on the velocity of the compressed air flow passing by the fuel port opening 88, directing the compressed air flow in this manner can help encourage fuel flow where the velocity of the compressed air flow is great enough to produce a sufficient pressure differential at the opening 88.

Such an arrangement in combination with perforations 94 in the common sidewall 82 help create turbulence in the combustor 80, which also facilitates mixing. In some embodiments, the combination of funneling compressed air flow so it converges adjacent to but downstream of the fuel port discharge opening 88 and perforate common sidewall construction not only encourages turbulent mixing, it also advantageously helps facilitate vaporization or atomization of fuel 70 in the combustor 80 where such fuel is not already in a vaporous or gaseous state.

To help minimize combustion chamber heat loss, including heat loss from compressed air flowing through the mixer 78, the combustion chamber 40 is of thermally insulated construction. For example, in the combustion chamber embodiment illustrated in FIG. 4, a layer of insulation 96 surrounds the outside surface of the outer sidewall 84. Such insulation not only helps prevent heat loss from compressed air in the chamber 40, it also helps reduce combustion heat loss from the combustor 80 as well.

FIG. 5 illustrates a cross-section of the cylinder head 54 shown in FIG. 4. Each valve 56 (valve 1) and 60 (valve 3) preferably is a poppet valve 98 having a valve head 100 and valve stem 102. The stem 102 can be biased, such as by a spring (not shown) or another biasing arrangement, toward a closed or open position. If desired, the stem 102 can be displaced by an actuator, such as an actuator of electromagnetic and/or electromechanical construction (not shown) that controls opening and closing of the valve 98. In some embodiments, valve operation is controlled by a camshaft (not shown) or the like that includes at least one lobed cam (not shown) rotation of which controls how long the valve 98 remains open and stays closed. When the valve is closed, the valve head 100 seats against a valve seat 104 opposing fluid flow by preferably providing a fluid-tight seal therebetween.

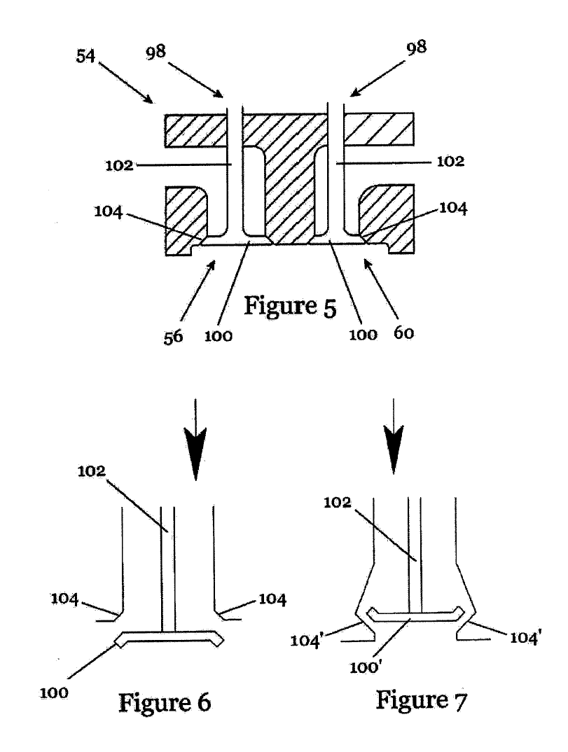

FIG. 6 illustrates one embodiment of a poppet valve that can be used that can self-seat in a closed position where fluid flow is reverse the direction of the directional arrow indicator shown. FIG. 7 shows a second embodiment of a poppet valve that can be used that can self-seat in a closed position where fluid flow is same as the direction of the directional arrow indicator shown.

In one cylinder head embodiment, the compressed air discharge valve 58 (valve 2) preferably is a poppet valve of the type same as or like that shown in FIG. 6 and the combustion gas intake valve 60 (valve 3) preferably is a poppet valve of the type same as or like that shown in FIG. 7. Likewise, the air intake valve 56 (valve 1) preferably is a poppet valve of the type same as or like that shown in FIG. 7 and the exhaust valve 62 (valve 4) preferably is a poppet valve of the type same as or like that shown in FIG. 6. In another embodiment, a valve arrangement that is the converse or reverse of the aforementioned valve arrangement is used.

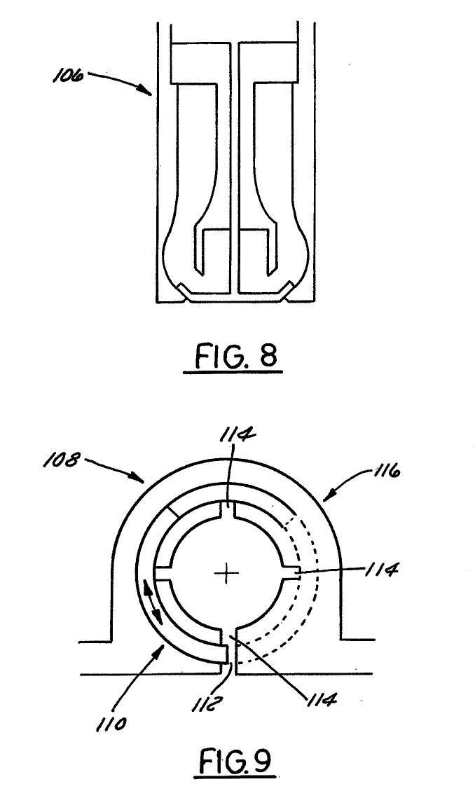

FIG. 8 illustrates another type of suitable valve 106 that is of needle valve type construction. FIG. 9 depicts an exemplary embodiment of a variable valve 108 whose timing and duration of valve opening, i.e., dwell, can be adjusted depending on factors that include engine operation, compression ratio, power, efficiency, noise, fuel type, etc. The variable valve 108 has a rotary slide 110 that includes at least one slot 112 that registers with a valve passage 114 in a valve body 116 permitting fluid flow there through and blocking fluid flow when the slide 110 is rotated to a position where it blocks the passage 114. An actuator (not shown), such as a rotary electromagnetic and/or electromechanical actuator (not shown) can be adapted to operate the valve. If desired, the valve 108 can also be mechanically driven, such as by a camshaft (not shown), a linkage arrangement (not shown), or another type of mechanical valve drive arrangement. If desired, another type of variable valve offering such control over valve timing and duration of valve opening can also be employed for any one of the valves 56, 58, 60 and 62 of the engine 30.

Control valves CV can be any of the variable valves or selectively actuated valves described herein, and also include corresponding control mechanisms. The control mechanisms of control valves CV can be housed at the valves them selves or at remote locations with respect thereto. Regardless, the control mechanism(s) determine where, for example, pressurized or other air should be routed, directed, or redirected, within engine 30 at any particular time and correspondingly actuate or otherwise control the control valves to realize such route. The decisions on where to route air at any given time and thus how to manage control valves CV are preferably based on monitoring various engine operating conditions.

Indeed, the entire valve-train including various ones of those housed in cylinder head 54 and the control valves CV are actuated or otherwise controlled based various ones of respective operational parameters related to, for example, crankshaft RPM speed, crankshaft position, throttle position, mass air flow or near the intake or throttle assembly, presence of any engine knock, air/fuel mixture leanness or richness, ambient temperature, air temperature and pressure entering combustion chamber 40, temperature and pressure within chamber 40, combustion gas temperature and pressure leaving chamber 40, exhaust gas temperature, engine coolant temperature, desired efficiency of chamber 40, and/or other desired operating conditions and parameters.

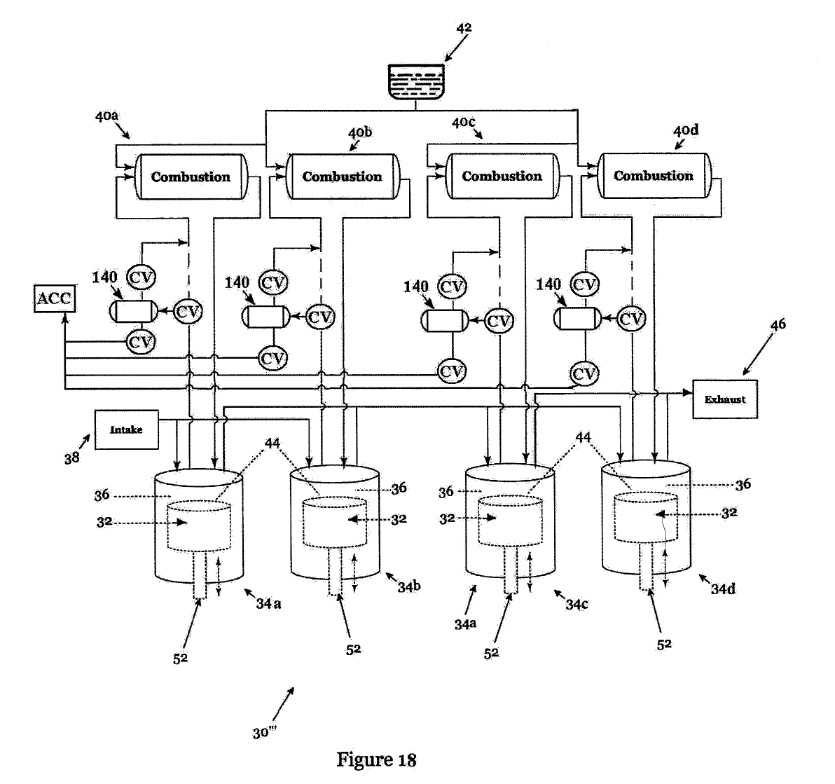

In addition, control valves CV, alone or in combination with other various valves and components, can enhance the plural functionality and operability of engine 30. As one example, control valves CV enable engine 30 to switch between 4 cycle, 6 cycle, 8 cycle, and cycle operation if needed augment power output, power density, efficiency, and/or energy storage. In multiple cylinder engines (FIG. 18), by managing the operation of control valve CV, alone or in combination with other various valves and components, as desired, various components of engine 30 can cooperate with other components which they typically do not operate with during default operating conditions. As one example, various combustion chambers can intake compressed air from and expel combustion gases to cylinders other than their respective supply cylinders.

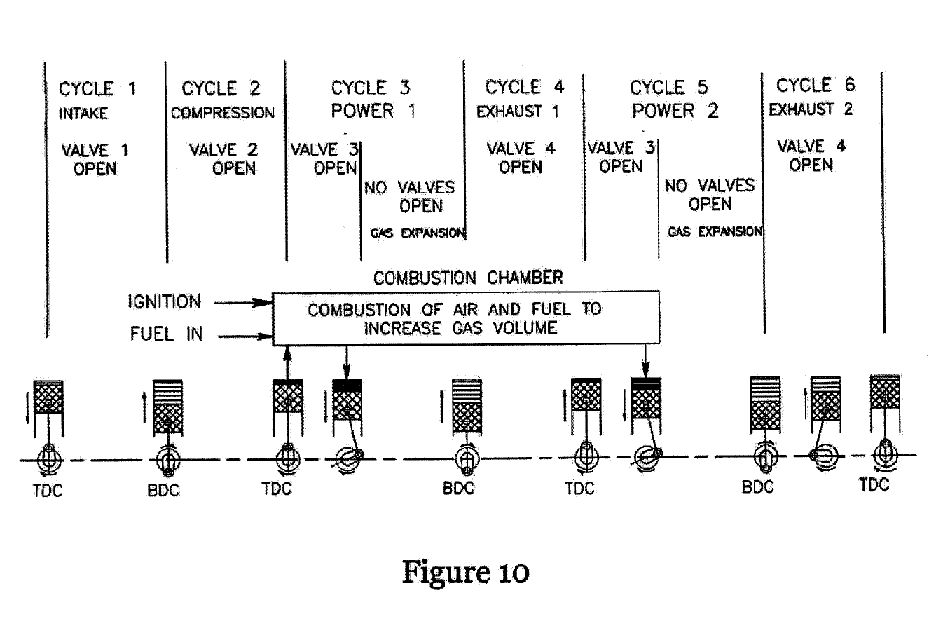

FIG. 10 illustrates a Brayton cycle or modified Brayton cycle, piston-type combustion engine cycle diagram for six cycle operation of the engine 30. At the beginning of cycle 1, the intake stroke, the head 44 of the piston 32 is at the TDC position. Work is inputted to displace the piston head 44 towards BDC while the air intake valve 56, valve 1, is open. As a result of the intake valve 56 being open, air is drawn into the cylinder 34 by suction created as a result of piston displacement towards BDC, optionally forced into or supplemented by forced induction mechanism F1.

When the air intake stroke (cycle 1) is completed, the intake valve 56 (valve 1) is closed. In some implementations, the compressed gas discharge valve 58 (valve 2) is appropriately opened during the compression stroke (cycle 2) while the piston 32 is displaced using inputted work towards the TDC position. Depending on the configuration of the engine 30, the present invention contemplates operation during the compression stroke with the discharge valve 58 remaining closed for at least part of the second cycle. For example, where engine operation upon startup is initially at a lower compression ratio, such as at a compression ratio of less than 8:1, the discharge valve 58 preferably remains open during the entire compression stroke. Thereafter, as compression builds reaching a compression ratio that is greater than the lower initial or startup compression ratio, such as at a compression ratio of 8:1 or greater in this example, the discharge valve 58 preferably remains closed for at least part of the time from the beginning of the compression stroke. Optionally, the when it is desired to operate relatively high efficiencies, engine 30 remains operating at low compression ratios and utilizes regenerative heat transfer to realize such high efficiencies.

If desired, the compressed gas discharge valve 58 (valve 2) and the various control valves CV can be controlled independently of the other valves 56, 60 and 62, such as where the valve 58 is directly driven via a pneumatic, electronic, electromagnetic, and/or electromechanical actuator or the like. Where the valve 58 is of one-way valve construction, e.g., poppet valve, needle valve, or the like, its operation will be dependent upon the operation of the combustion gas intake valve 60 (valve 3), fuel input, compression ratio, and/or desired power output.

Where a discharge valve control regime is adopted that allows the discharge valve 58 to remain closed for at least part of the compression stroke, the time the valve is to remain closed, DVt_{c}, preferably relates to the air pressure compression desires to achieve. For example, in some implementations, discharge valve close time, DVt_{c}, is chosen so the pressure of the compressed air discharged from the cylinder when the valve 58 is opened is substantially the same as the pressure within the combustion chamber 40 or pressure vessel 140. In some implementations, DVt_{c}, is chosen so the pressure of the compressed air discharged from the cylinder 34 is substantially the same as the pressure within the combustion chamber 40 at or adjacent its inlet 66, or pressure multiplier 142 adjacent pressure vessel 140. In various implementation, valve timing is controlled or otherwise regulated to achieve a compressed air discharges pressure that is within ±25% of the pressure within the combustion chamber 40, inlet 66, pressure vessel 140, or pressure multiplier 142.

In one exemplary method of operation, the discharge valve 58 remains open throughout substantially the entire compression stroke while the engine is operating at a first compression ratio, CR₁. When it is desired to increase the compression ratio, the discharge valve 58 remains closed for a period of time, t₁, preferably starting from the beginning of the compression stroke. In some method implementations, the discharge valve close time, DVt_{c}, of the discharge valve 58 is increased from t₁, to a value greater than t₁ as compression ratio increases. This can be done to help bring about an increase in compression ratio and/or can also be done in response to increasing compression ratio occurring during engine operation.

One implementation contemplates adjusting in response to a change in pressure sensed downstream of the cylinder, such as preferably within the combustion chamber 40 at or adjacent the inlet, optionally within the pressure vessel 140 or pressure multiplier 142. As will be discussed below, the timing of the combustion gas intake valve 60 (valve 3) can be controlled to cause the pressure within the combustion chamber 40 or pressure vessel 140 to rise or fall. For example, where the combustion gas intake valve open time, CGIVt₀, is decreased to less than that needed to ensure optimal gas expansion during the two power strokes (cycle 4 and cycle 6) depicted in FIG. 10, gas pressure will build up within the combustion chamber 40 and/or pressure vessel 140 as a result. Where gas pressure in the combustion chamber 40 or pressure vessel 140 increases, the discharge valve close time, DVt_{c}, of the compressed air discharge valve 58 (valve 2) is increased by a sufficient amount to help ensure the pressure of the compressed gas discharged from the cylinder 34 is substantially the same as the pressure within the combustion chamber 40, pressure vessel 140, or pressure multiplier 142.

In one engine embodiment, a variable valve, such as the valve 108 shown in FIG. 9, can be employed as the compressed gas discharge valve 58 enabling discharge valve close time, DVt_{c}, to be regulated during each compression stroke as needed either in response to a change in compression ratio and/or downstream pressure or to help bring about a change in compression ratio and/or downstream pressure. In one compression stroke implementation, the discharge valve 58 stays closed for at least 5% of the compression stroke. In another implementation, the valve 58 stays closed for at least 50% of the compression stroke. In still another implementation, the discharge valve close time, DVt_{c}, is selected so the discharge valve opens when the piston 32 is located at least within about ±5° of TDC. Other compressed gas discharge valve implementations and control regimes are possible.

After the compression stroke (cycle 2) is completed, the compressed air discharge valve 58 (valve 2) is closed if need be and the combustion gas intake valve 60 (valve 3) is opened beginning the first power stroke (cycle 3). Depending on the particular configuration of engine 30, the combustion gas either passes through the turbine side of turbocharger FI(1), optionally directly into cylinder 34 through combustion gas intake valve 60 (valve 3), or partially both, as dictated by control valve CV.

Regardless of the particular flow path which the combustion gas takes, the intake valve 60 remains open for e.g. less than the entire period of time it takes for the piston 32 to be driven to the BDC position by the expanding combustion gases that have entered the cylinder 34. In one implementation, the combustion gas intake valve open time, CGIVt₀, is selected to be less than 50% of the time it takes for the piston to travel from the TDC position to the BDC position. In another implementation, CGIVt₀, is selected to be long enough to maximize the amount of combustion gas expansion, including any expansion that takes place within the cylinder 34 after the intake valve 60 closes.

Where it is assumed that at least one more power stroke (e.g., cycle 5) takes place after the first power stroke (cycle 3), the combustion gas intake valve open time, CGIVt₀, is determined based on the maximum working fluid chamber volume within the cylinder, the current compression ratio, and the expansion ratio resulting from the fuel type or mixture as well as the fuel-air ratio resulting from combustion of the mixture in the combustion chamber 40. In one implementation, a volumetric total amount of gas expansion occurring during combustion is determined based on this expansion ratio given the fuel type and/or mixture and the fuel-air ratio. If desired and suitable for use, the fuel-air ratio can be relative to stoichiometric. This volumetric total is then divided by the maximum working fluid chamber volume of the cylinder 34 times the number of power strokes per complete engine operating cycle. CGIVt₀ is then determined based on the time it will take for enough expanding combustion gases to enter the cylinder during each power stroke to optimize power obtained during each power stroke. Preferably, the value of CGIVt₀ obtained helps ensure that substantially complete expansion of the combustion gases takes place or substantially complete combustion gas expansion is approached thereby helping optimize engine operating efficiency.

After the first power stroke (cycle 3) is completed, the exhaust valve 62 is opened permitting the combusted expanded gases in the cylinder 34 to be exhausted from the cylinder 34 during a first exhaust stroke (cycle 4). Preferably, the exhaust valve 62 is opened at or after the piston 32 has reached BDC such that subsequent piston displacement toward TDC helps discharge the exhaust gases from the cylinder 34 during the exhaust stroke.

Upon completion of the first exhaust stroke (cycle 4), the exhaust valve 62 is closed. At or after the piston 32 reaches the TDC position, the combustion gas intake valve 60 is reopened to enable combustion gases whose expansion is not yet complete to enter the cylinder 34 during the second power stroke (cycle 5) and drive the piston 32 toward the BDC position extracting additional power from the combustion gases. While the combustion gas intake valve open time, CGIVt₀, can differ in the second power stroke, it can also be substantially the same, if desired.

In one implementation of the CGIVt₀ determination method discussed above, CGIVt₀ for the first power stroke (cycle 3) is shorter in duration than CGIVt₀ for the second power stroke (cycle 5). This is because combustion gases entering the cylinder 34 during the first power stroke causes the pressure of the combustion gases that remain upstream of the cylinder 34 to decrease from a maximum combustion gas pressure that existed before the combustion gas intake valve 60 opened during the first power stroke. As a result and where the maximum working fluid chamber volume remains unchanged in the cylinder 34, the value of CGIVt₀ for the first power stroke preferably will be determined or otherwise selected to be less (shorter) than the value of CGIVt₀ for the second power stroke. This is because the combustion gas intake valve 60 must remain open for a longer period of time during the second power stroke than it did for the first power stroke to maximize volumetric filling of the working fluid chamber of the cylinder 34 due to the lower gas pressure. Keeping the valve 60 open longer during the second power stroke preferably helps optimize operating efficiency by helping to maximize power extracted from the expanding combustion gases during the second power stroke.

In other implementations, as desired for short durations, engine 30 uses stored compressed air within pressure vessel 140 to substantially recreate a second power stroke which is closely analogous to the first, preceding, power stroke. Accordingly, in such implementations, the CGIVt₀ for the first power stroke (cycle 3) is generally the same in duration as the CGIVt₀ for the second power stroke (cycle 5). This is because upon releasing a burst of pressurized air from pressure vessel 140 and correspondingly introducing an increased volume of fuel 70, engine 30 recreates generally the same operating conditions within the combustion chamber 40 during the second power stroke (cycle 5) as compared to those of the first power stroke (cycle 3).

In other words, as desired, engine 30 introduces compressed air to reduce the effect of any operational discontinuities caused by cyclically pumping air into combustion chamber 40 by reciprocation of piston 32 alone. Or compressed air can be introduced from pressure vessel 140 into combustion chamber 40 to merely output more power from engine 30.

Accordingly, for short periods of time in which engine 30 utilizes compressed air from pressure vessel 140 to feed combustion chamber 40, the chamber 40 performs substantially as though it were fed by a continuous pressure source such as a rotary compressor in stead of the reciprocating compression provided by cylinder 34. This temporary pulse of air feed into combustion chamber 40 from pressure vessel 140 enhances the consistency or stability of the output flow of combustion gases from the chamber 40 and the continuity of pressure within chamber 40. Correspondingly, injecting compressed air from pressure vessel 140 into chamber 40 enables the engine 30 to perform multiple, sequential, power strokes which are substantially equivalent, for distinct periods of time.

After the second power stroke (cycle 5) is completed, the exhaust valve 62 is once again opened permitting the combusted expanded gases in the cylinder 34 to be exhausted from the cylinder 34 during a second exhaust stroke (cycle 6). Preferably, the exhaust valve 62 is also once again opened at or after the piston 32 has reached BDC such that piston displacement toward TDC helps discharge the exhaust gases from the cylinder 34 during the second exhaust stroke.

Upon completion of the complete six cycle engine operating cycle depicted in FIG. 10 in accordance with the present invention, the piston 32 preferably is located at or near TDC, enabling the six cycle engine operating cycle to be repeated as needed during engine operation.

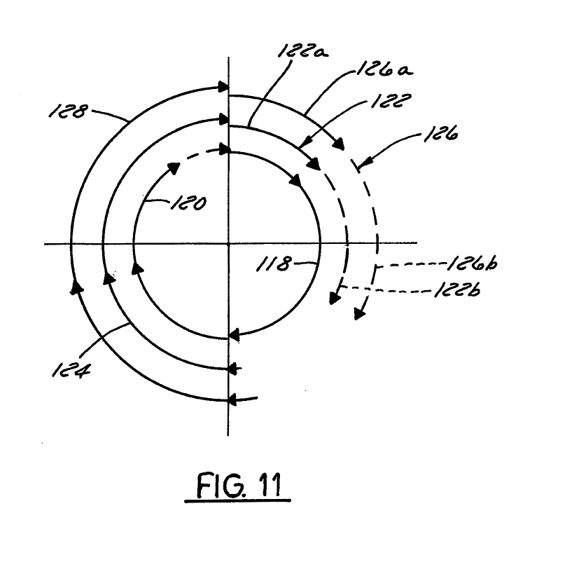

FIG. 11 is a valve function diagram depicting six cycle operation of an engine 30 constructed in accordance with the present invention. The engine 30 has a rotary cam (not shown) that drives one or more of the valves 56, 58, 60 and 62, during six cycle engine operation at one-third engine speed. With reference to a radially innermost right-hand side clockwise-extending air intake valve opening curve 118, the air intake valve 56 (valve 1) is open during the intake stroke (cycle 1) for about 180° of crankshaft rotation before closing. A compressed air discharge valve curve 120 is on the opposite side and shows in an embodiment in which the compressed air discharge valve 58 (valve 2) also stays open for about 180° of crankshaft rotation during the compression stroke (cycle 2). In another implementation, valve 58 stays open for between 5° and 120°.

Located radially outwardly of curve 118 is a first combustion gas intake valve curve 122 depicting operation of the combustion gas intake valve 60 (valve 3) during the first power stroke (cycle 3). As is depicted in FIG. 11, the valve 60 preferably remains open for anywhere between 15° of crankshaft rotation, as indicated by solid line 122a, and 150° of crankshaft rotation, as indicated by dashed line 122b. The valve 60 is closed where no solid or dashed line exists. In the valve function diagram shown in FIG. 11, the valve 60 is open anywhere from the last 15° of crankshaft rotation to the last 150° of crankshaft rotation, before bottom dead center (BBDC). In another implementation, valve 60 is open between 4° of crankshaft rotation and 90° of crankshaft rotation BBDC. The valve 60 can always be open at the end of the power stroke.

Thereafter, as is depicted by a first radially innermost exhaust valve curve 124, the exhaust valve 62 (valve 4) remains open for substantially the entirety of the first exhaust stroke (cycle 4). Once the first exhaust stroke is completed, a second power stroke (cycle 5) takes places as indicated by radially outermost right hand side curve 126. As is shown by the curve 126, the combustion gas intake valve 60 (valve 3) operates substantially the same as depicted by the first combustion gas intake valve curve 122. Once the second power stroke is completed, the second exhaust stroke (cycle 6) is performed in the manner depicted by radially outermost left hand side curve 128, which preferably is substantially the same as described above with regard to exhaust valve curve 124.

In one embodiment, the combustion gas intake valve 60 preferably is a variably adjustable valve of the type depicted in FIG. 9 and the compressed air discharge valve 58 preferably is a pressure actuated valve such as of the type illustrated in FIG. 8. In another embodiment, all of the valves 56, 58, 60 and 62 are poppet valves.

FIG. 12 illustrates a first series of pressure-volume plots for a low power output case where the compression ratio is approximately 3:1, V_{combustion}/V_{compression}≅1.3, exhaust gases are discharged into the environment substantially at ambient, and a low 4.3 power output, and 11.4P/7.06C=1.62. In this six cycle engine operation example, a 3:1 compression ratio is reached during the compression stroke when the piston 32 is within approximately 29.6% of its total stroke. At this point, further piston displacement results in compressing air within the cylinder 34 at a substantially constant pressure for the rest of the stroke (29.6%). In this example, the volume of the compressed air at the pressure developed from the approximately 3:1 compression ratio is expanded approximately 1.3 times per the above V_{combustion}/V_{compression} ratio. Since there are two power strokes resulting from an engine 30 constructed in accordance with the invention using the same piston-cylinder arrangement for both power strokes, each power stroke will result in the working fluid chamber 36 defined by the piston-cylinder arrangement having a maximum volume that is one-half of the volume combustion gases. This means that the combustion gas intake valve 60 will need to be open about 20% of the piston stroke during each power stroke of six cycle engine operation. The combustion ratio is reduced by a small amount because of a small dead space occurring between the top of the piston and the top of the cylinder bore at Top Dead Center. This dead space is evident from the area between the curve in FIG. 12.

The ratio between the percentage of piston stroke during which the combustion gas intake valve 60 is open and piston stroke percentage during the compression stroke provides guidance as to power output. In the present example, 20%÷29.6%=0.67, which indicates lower power output because it is less than 1.

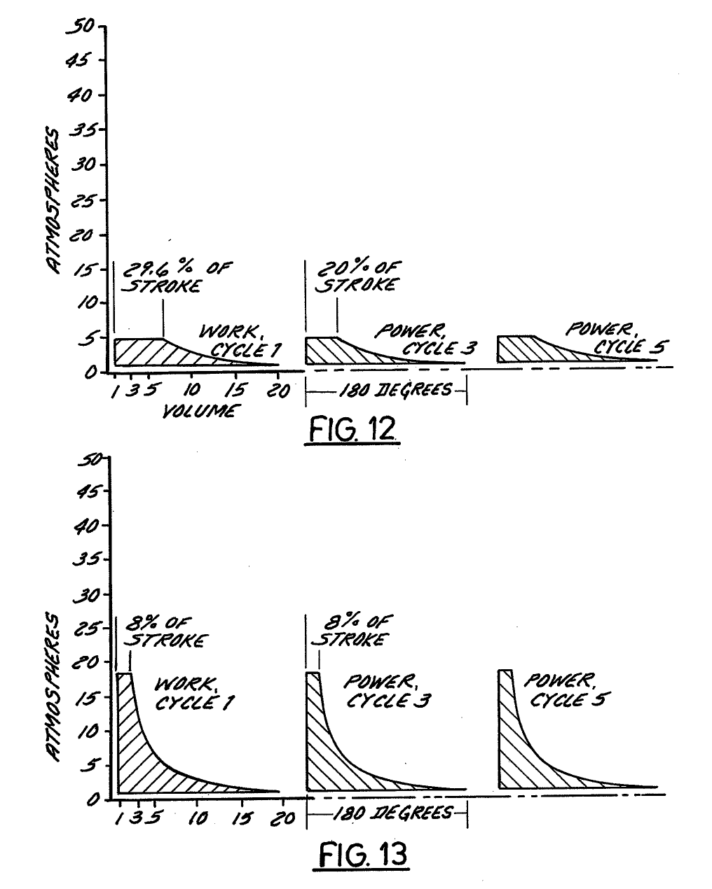

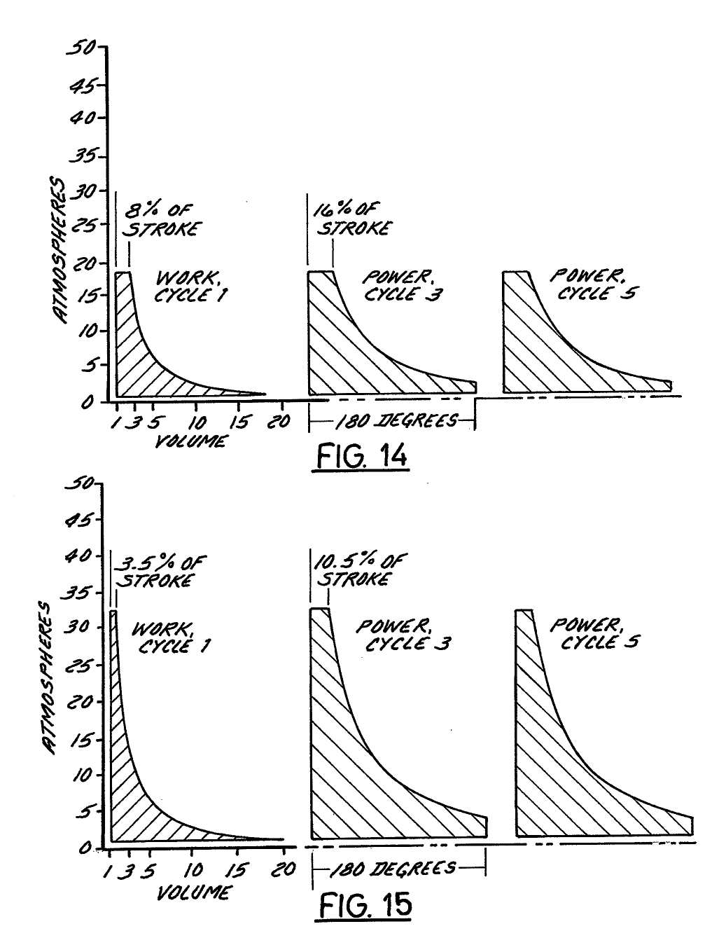

FIG. 13 illustrates a second series of pressure-volume plots for a moderate-low power output case where the compression ratio is 8:1, V_{combustion}/V_{compression}=2, exhaust gases are discharged into the environment substantially at ambient, 14.7 output, and 29.4P/14.7C=2. In this six cycle engine operation example, an 8:1 compression ratio is reached during the compression stroke when the piston 32 is within approximately 8% of its total stroke. At this point, further piston displacement results in compressing air within the cylinder 34 at a substantially constant pressure for the rest of the stroke (8%). In this example, the volume of the compressed air at the pressure developed from the 8:1 compression ratio is expanded 2 times per the above V_{combustion}/V_{compression} ratio. Since there are two power strokes resulting from an engine 30 constructed in accordance with the invention using the same piston-cylinder arrangement for both power strokes, each power stroke will result in the working fluid chamber 36 defined by the piston-cylinder arrangement having a maximum volume that is one-half of the volume combustion gases expand as result. This means that the combustion gas intake valve 60 will need to be open about 8% of the piston stroke during each power stroke of six cycle engine operation.

FIG. 14 illustrates a third series of pressure-volume plots for a moderate power output case where the compression ratio is approximately 8:1, V_{combustion}/V_{compression}≅4, exhaust gases are discharged into the environment substantially at about 2.5 atmospheres absolute, 40 power output, and 56.6P/14.7C=3.8. In this six cycle engine operation example, an 8:1 compression ratio is reached during the compression stroke when the piston 32 is within approximately 8% of its total stroke. At this point, further piston displacement results in compressing air within the cylinder 34 at a substantially constant pressure for the rest of the stroke (8%). In this example, the volume of the compressed air at the pressure developed from the approximately 8:1 compression ratio is expanded 4 times per the above V_{combustion}/V_{compression} ratio. Since there are two power strokes resulting from an engine 30 constructed in accordance with the invention using the same piston-cylinder arrangement for both power strokes, each power stroke will result in the working fluid chamber 36 defined by the piston-cylinder arrangement having a maximum volume that is one-half of the volume combustion gases expand as result. This means that the combustion gas intake valve 60 will need to be open about 16% of the piston stroke during each power stroke of six cycle engine operation.

FIG. 15 illustrates a fourth series of pressure-volume plots for a high power output case where the compression ratio is approximately 12:1, V_{combustion}/V_{compression}≅6, exhaust gases are discharged into the environment substantially at about 4.1 atmospheres absolute, 73.3 power output, and 90.9P/14.7C=5.2. In this six cycle engine operation example, a 12:1 compression ratio is reached during the compression stroke when the piston 32 is within approximately 3.5% of its total stroke. At this point, further piston displacement results in compressing air within the cylinder 34 at a substantially constant pressure for the rest of the stroke (3.5%). In this example, the volume of the compressed air at the pressure developed from the approximately 12:1 compression ratio is expanded 6 times per the above V_{combustion}/V_{compression} ratio. Since there are two power strokes resulting from an engine 30 constructed in accordance with the invention using the same piston-cylinder arrangement for both power strokes, each power stroke will result in the working fluid chamber 36 defined by the piston-cylinder arrangement having a maximum volume that is about one-half of the volume combustion gases expand as result. This means that the combustion gas intake valve 60 will need to be open about 10.5% of the piston stroke during each power stroke of six cycle engine operation.

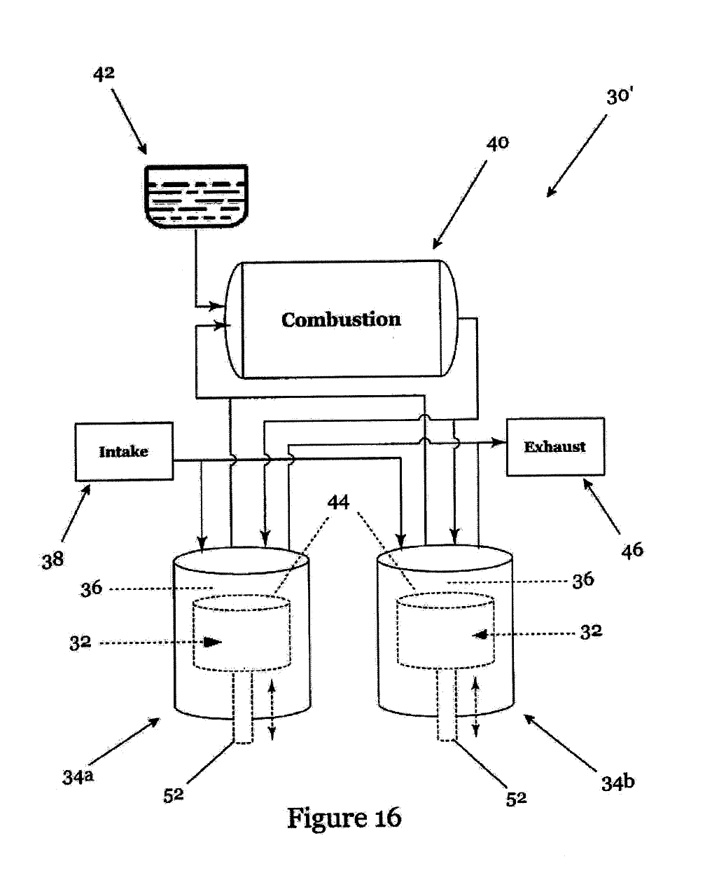

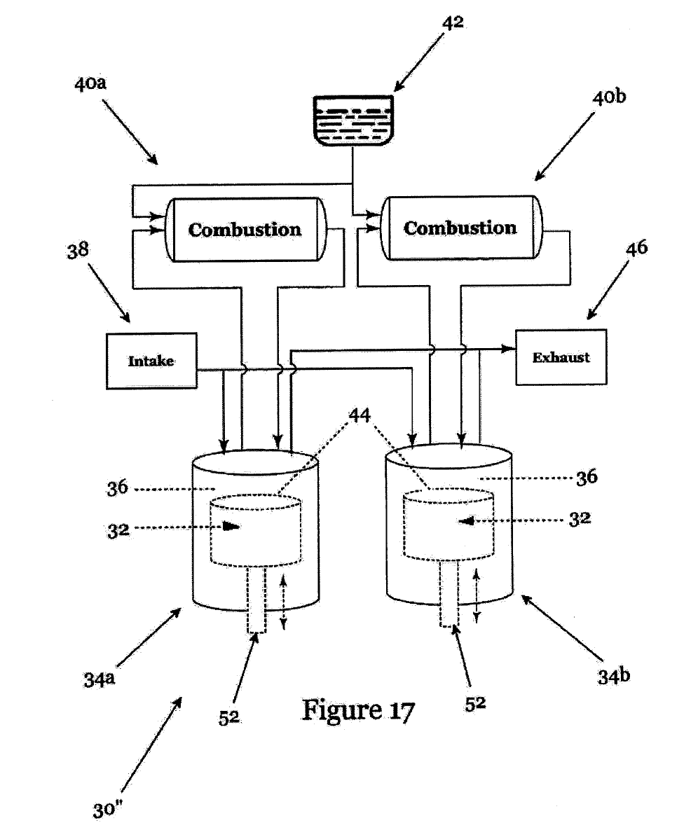

FIG. 16 illustrates another embodiment of an engine 30′ constructed in accordance with the present invention that is capable of being configured for multiple power stroke operation. Engine 30′ is similar to the engine shown in FIG. 3A except that a plurality of cylinders 34a and 34b are employed. Each cylinder 34a and 34b preferably includes a valve arrangement having at least a plurality of pairs of valves, e.g., at least three valves, that control air intake, compression, combustion gas intake, and exhaust in a manner that enables multiple power stroke operation.

For example, in some embodiments, each cylinder 34a and 34b can have a cylinder head the same as or like the cylinder head depicted in FIG. 4 that includes an air intake valve 56, compressed air discharge valve 58, a combustion gas intake valve 60, and an exhaust valve 62. Each cylinder 34a and 34b preferably operates substantially same as the single cylinder engine 30 shown in ones of FIGS. 3A, 3B, 3C, 3D, and 4, with combustion chamber 40 operation being substantially continuous due to both cylinders 34a and 34b alternately discharging compressed air to the chamber 40 and accepting combustion gases from the chamber 40 undergoing expansion.

In one implementation, valve timing for each cylinder head of each cylinder 34a and 34b preferably is controlled to adequately stagger corresponding valve operation and piston displacement so each cylinder 34a and 34b operates in tandem. In another implementation, valve timing is substantially coincident so each cylinder 34a and 34b operates substantially in unison having substantially similar valve operation and piston displacement occurring at the same time.

In another implementation using the embodiment shown in FIG. 16, only one of the cylinders, such as cylinder 34a, is used to compress air delivered to the combustion chamber 40. Thereafter, after combustion, expanding combustion gases are discharged from the combustion chamber 40 to cylinder 34a and cylinder 34b. Therefore, two power strokes are employed with one being performed by one cylinder 34a and the other being performed by the other cylinder 34b.

FIGS. 17 and 18 illustrate still further embodiments of engines 30″ and 30′″, respectively, which are constructed in accordance with the present invention and capable of being configured for multiple power stroke operation. Engine construction is similar to that of the engine 30 shown in FIGS. 3A, 3B, 3C, 3D, and 4 and engine 30′ illustrated in FIG. 16 except that there are also a plurality of combustion chambers 40b and 40a in addition to having a plurality of cylinders 34a and 34b. FIG. 18 shows an embodiment which also includes a plurality of pressure vessels 140, in addition to a plurality of combustion chambers and cylinders. While a common intake 38 and exhaust 46 are shared, both cylinders 34a and 34b and corresponding combustion chambers 40a and 40b are capable of operating substantially independently. If desired, where a common crankshaft (not shown) and/or camshaft is employed, valve operation can be controlled as discussed above for substantially simultaneous and tandem/staggered operation.

One advantage of multiple cylinder embodiments is the variety of operating configurations and ability to switch and adapt between such configurations, even during operational use. By managing the control valves CV and/or other various valves and components such as ones of e.g. the cylinders 34, combustions chambers 40, pressure vessels 140, or other components, can be fluidly connected to other ones of such components, which in default operation are non-corresponding. In other words, by way of control valves CV, as desired, all of the cylinders 34 can supply compressed air to a single pressure vessel 140 or a single combustion chamber 40, or the various components of engine 30′″ can enjoy and switch between otherwise fluid routing configurations.

In multiple cylinder engines (FIG. 18), by managing the operation of control valve CV, alone or in combination with other various valves and components, as desired, various components of engine 30 can cooperate with other components which they typically do not operate with during default operating conditions. As one example, various combustion chambers can intake compressed air from and expel combustion gases to cylinders other than their respective supply cylinders.

In other words, based on the intended use and the desired amount of operational re-configurability and alternatives, the particular engine 30, 30′, 30″, or 30′″ includes other e.g. tubing sections and control valves CV, not necessarily illustrated herein, which fluidly connect (selectively by way of control valves CV), the various components to each other that the uses wants the option of fluidly connecting during operation.

It is also understood that in any embodiments of engine 30, including multiple cylinder implementations, the number, size, and configurations of the various components are selected based on the intended end use of the device. Accordingly, as one example, some implementations include a plurality of cylinders 34 and only one combustion chamber 40, or only one pressure vessel 140, whilst other embodiments include a plurality of relatively smaller combustion chambers 40, each of which is configured to produce relatively higher combustions pressures, or other configurations as desired.

It is an advantage of the engine of the present invention that is configurable to enable fuel to be delivered to the combustion chamber 40 in a manner that achieves and preferably optimizes high pressure pulses timed in relation to the opening of the combustion gas intake valve 58 enabling higher efficiency. It is another advantage of the present invention that timing of the exhaust valve 62 preferably is configured to permit adjustment, including during engine operation and in real time, facilitating achieving high efficiency at a wide range of partial throttle settings. This also advantageously enables higher output to be obtained at very high throttle settings, including wide open throttle. This preferably is done or facilitated by the production of an excessive volume of combustion gases helping to achieve maximum and preferably substantially full combustion gas expansion.

An engine 30 configured in accordance with the present invention preferably is configurable to enable adjustment of the compression ratio by adjusting the timing of the combustion gas intake valve 64 along with the amount of fuel, e.g. fuel consumption rate, combusted in the combustion chamber 40 to enable compression ratio to be raised or lowered during engine operation thereby also enabling a corresponding increase or decrease in the pressure in the chamber 40.

An engine 30 configured in accordance with the present invention can be configured to perform a plurality of pairs of power strokes during a complete engine cycle.

In another embodiment, the combustion chamber 40 is equipped with multiple compartments. In a still further embodiment, the combustion chamber 40 is configured to be expandable so as to provide an adjustable volume combustor or the like where combustion volume is variable, including preferably in real time and/or during engine operation.

As discussed in greater detailer elsewhere herein, as desired, water, methanol, propane, or other suitable liquids, can be injected in addition to fuel into the combustion chamber 40 or just before combustion gases enter the working fluid chamber of the cylinder 34 for limiting combustion temperatures preferably advantageously lowering nitrogen oxide emissions. Doing so can also lower engine temperatures, reducing adverse effects of thermal cycling and the like.

In one embodiment, the intake 38 preferably can be configured to house the throttle and air intake upstream of the intake valve 56 for low idle operation and engine operating adjustment.

It is also to be understood that, although the foregoing description and drawings describe and illustrate in detail one or more preferred embodiments of the present invention, to those skilled in the art to which the present invention relates the present disclosure will suggest many modifications and constructions as well as widely differing embodiments and applications without thereby departing from the spirit and scope of the invention.

It is claimed:

1. A combustion engine comprising:
(a) a reciprocable piston received in a cylinder;
(b) a valve assembly permitting fluid flow into and out of the cylinder;
(c) a combustion chamber which is displaced and distinct from the cylinder; and
(d) a variable valve effecting fluid flow between the cylinder and the combustion chamber.

2. The combustion engine of claim 1 wherein the variable valve comprises a rotary valve.

3. The combustion engine of claim 1 wherein gas is compressed by the piston in the cylinder and discharged from the cylinder and mixed with fuel, the fuel and gas mixture is combusted externally of the cylinder producing combustion gases, and the combustion gases are directed into the cylinder to perform work on the piston and displace the piston to output power therefrom.

4. The combustion engine of claim 3 wherein the same cylinder that compresses the gas receives the combustion gases undergoing expansion from being combusted.

5. The combustion engine of claim 2 wherein the rotary valve selectively permits flow from the combustion chamber to the cylinder.

6. The combustion engine of claim 2 wherein the rotary valve selectively permits flow from the cylinder to the combustion chamber.

7. The combustion engine of claim 1 further comprising a pressure vessel for accepting pressurized gas expelled from the cylinder and storing the gas, under pressure, therein.

8. The combustion engine of claim 1 further comprising a pressure vessel, for storing pressurized gas, in fluid communication with cylinder and the combustion chamber.

9. The combustion engine of claim 8 further comprising a valve in fluid communication with the cylinder, the pressure vessel, and the combustion chamber, which selectively directs fluid flow from the cylinder to one of the pressure vessel and the combustion chamber.

10. The combustion engine of claim 8 further comprising a valve in fluid communication with the cylinder, the pressure vessel, and the combustion chamber, which permits simultaneous fluid flow from the cylinder to both the pressure vessel and the combustion chamber.

11. The combustion engine of claim 1 further comprising a forced air induction mechanism in communication with the cylinder.

12. The combustion engine of claim 11, the forced air induction mechanism comprising a turbocharger having a turbine side and a compressor side, the turbine side in fluid communication with the combustion chamber and the compressor side in fluid communication with the cylinder.

13. The combustion engine of claim 12, the forced air induction mechanism comprising a turbocharger having a turbine side and a compressor side, the turbine side in fluid communication with the combustion chamber and the compressor side in fluid communication with the combustion chamber.

14. The combustion engine of claim 12, the forced air induction mechanism comprising a supercharger having a compressor which is in fluid communication with the cylinder.

15. The combustion engine of claim 12, the forced air induction mechanism comprising a supercharger having a compressor which is in fluid communication with the combustion chamber.

16. A combustion engine comprising:
(a) a reciprocable piston received in a cylinder;
(b) a pressure vessel in fluid communication with the cylinder and storing a volume of compressed air therein;
(c) a combustion chamber having (i) a compressed air inlet permitting compressed airflow from the pressure vessel to the combustion chamber, and (ii) combustion gas outlet in fluid communication with the combustion chamber and the cylinder;
wherein a volume of combusted gas, combusted in the combustion chamber, flows from the combustion chamber to the cylinder.

17. The combustion engine of claim 16 wherein a gas is compressed by the piston in the cylinder, expelled from the cylinder, and directed to either the pressure vessel or the combustion chamber.

18. The combustion engine of claim 16 wherein a gas is compressed by the piston in the cylinder, expelled from the cylinder, and directed to both the pressure vessel and the combustion chamber.

19. The combustion engine of claim 16 wherein the pressure vessel includes a valve for outputting pressurized gas therefrom, so as to provide pneumatic power.

20. The combustion engine of claim 19 wherein the pneumatic power drives an pneumatic accessory.

21. The combustion engine of claim 16 further comprising a valve in fluid communication with the cylinder, the pressure vessel, and the combustion chamber, which influences fluid flow from the cylinder to the pressure vessel and the combustion chamber.

22. The combustion engine of claim 21 wherein the valve selectively permits fluid flow from the cylinder to one of the pressure vessel and the combustion chamber.

23. The combustion engine of claim 21 wherein the valve selectively permits simultaneous fluid flow from the cylinder to both the pressure vessel and the combustion chamber.

24. A method comprising:
(a) admitting a volume of air into a cylinder;
(b) moving a piston in the cylinder to pressurize the air and reduce the volume thereof;
(c) directing pressurized air into a pressure vessel;
(d) selectively directing pressurized air from the pressure vessel to a combustion chamber;
(e) directing a volume of fuel into the combustion chamber to mix with a volume of air and igniting the fuel/air mixture so as to produce combustion gases having a relatively greater volume with respect to the pre-combusted fuel/air mixture; and
(f) directing the combustion gases, in a plurality of discrete pulses, from the combustion chamber into a cylinder to displace a piston in the cylinder a plurality of times, wherein the number of piston displacements corresponds to the number to combustion gas pulses introduced into the cylinder.

25. The method of claim 24 wherein the introduction of combustion gas pulses is controlled by a variable valve.

26. The method of claim 25 wherein the variable valve is a rotary valve.

27. The method of claim 24 wherein the volume of air is admitted into the cylinder by way of a forced air induction mechanism.

28. The method of claim 27 wherein the forced air induction mechanism comprises a turbocharger.

29. The method of claim 28 wherein the forced air induction mechanism comprises a supercharger.

30. The method of claim 24, further comprising the step of monitoring the temperature of the pressurized air being directed out of the cylinder and defining a corresponding air temperature value.

31. The method of claim 30, in response to the magnitude of the air temperature value, injecting a volume of water into the volume of air and reducing the relative temperature of the air.

32. The method of claim 31, wherein the determination of whether to inject water is based on a relationship between the air temperature value and the flash point of a fuel which is introduced into the combustion chamber.

33. The method of claim 31, wherein some of the pressurized air is directed from the pressure vessel to an engine accessory, pneumatically powering the engine accessory.
